(19) United States
(12) Patent Application Publication
(10) Pub. No.: US 2009/0112353 A1
(43) Pub. Date: Apr. 30, 2009

(54) SYSTEM AND METHOD FOR DESIGN OF STITCHED OBJECTS

(75) Inventors: Husein KIREFU, Waterloo (CA); Mesbah Abdulrahem, Waterloo (CA)

Correspondence Address: BORDEN LADNER GERVAIS LLP;Anne Kinsman, WORLD EXCHANGE PLAZA, 100 QUEEN STREET SUITE 1100, OTTAWA, ON, K1P 1J9, CA

(73) Assignee: Smartpatterns Inc., Waterloo (CA)

(21) Appl. No.: 12/240,594

(22) Filed: Sep. 29, 2008

Related U.S. Application Data
(60) Provisional application No. 60/976,026, filed on Sep. 28, 2007.

(51) Int. Cl. G06F 19/00; D04B 15/66; G06F 17/30

(52) U.S. Cl. 700/131; 66/75.2; 707/201

(57) ABSTRACT

A system and method for designing a stitched object, the system and method including: determining a style; determining a size; determining a stitch material; automatically calculating a grid-based template based on the determined style, size and stitch material; and outputting the grid-based template to a user as a design for the stitched object. The system and method also allow for an automatic change in gauge, for example, due to changes in patterns (motifs, stitch types or the like), yarns, user gauge, or the like.

### RELATED APPLICATION

This application claims the benefit of and priority from U.S. Provisional Patent Application No. 60/976,026, filed Sep. 28, 2007, and which is hereby incorporated herein by reference.

### FIELD

This application relates to systems and methods for design of stitched objects, and in particular, to systems and methods for the design of grid-based objects or materials such as knits, crochets, needlepoints and the like and the rendering of stitched materials on a digital display.

### BACKGROUND

Various stitching techniques have been passed down over many years, including knitting, crocheting, needlepoint, and the like. These techniques generally involve the use instructions of patterns that can be used by the person making the material, object or garment to form the shape of the material, object or garment and also to include patterns (motifs, stitch patterns, color patterns) into the material, object or garment.

There are various methods for representing these instructions, however, it can be difficult to resize objects or adjust the size of particular patterns (for example, motifs) within a particular garment without detailed knowledge and skill.

Various attempts to provide computer programs for such purposes have been attempted but such computer programs have had limited functionality, have generally not been capable of providing realistic rendering of the object as it will look when complete, and have lacked detailed instructions.

As such, there is an on-going need for an improved system and method of designing and rendering stitched materials or objects.

### SUMMARY

According to one aspect of embodiments described herein, there is provided a method for designing a stitched object, the method including: determining a style; determining a size; determining a stitch material; automatically calculating a grid-based template based on the determined style, size and stitch material; and outputting the grid-based template to a user as a design for the stitched object.

As most stitching designs must specify the size which the design makes or the stitch materials that can be used, this aspect provides the benefit that the grid-based design for the stitched object can be made automatically after a size or stitch material is selected.

In a particular case, the calculating a grid-based template may include determining a base template for the determined style, applying the determined size to the template to produce a sized template, and applying a property of the determined stitched material to the sized template to produce the grid-based template.

In another case, the method may further include: determining a pattern and the calculating is also based on the determined pattern. In this case, the grid-based template may be designated a material-specific template and the calculating a grid-based template may include applying the pattern to the material-specific template to produce the grid-based template.

In yet another case, the method may further include: determining a user gauge and the calculating is also based on the user gauge. In this case, the grid-based template may be designated a material-specific template and the calculating a grid-based template may include applying the user gauge to the material-specific template to produce the grid-based template.

In yet another case, the outputting may include generating instructions for making the stitched object based on the grid-based template and outputting the instructions to a user.

According to another aspect, there is provided a method for designing a stitched object, the method including: receiving a grid-based template for the object; receiving a new gauge for the object; automatically calculating a new grid-based template for the object; and outputting the new grid-based template to a user as a design for the stitched object. In this case, the new gauge may be received by user input of a user gauge.

According to yet another aspect, there is provided a system for designing a stitched object, the system including: a style module for input of a style;

a size module for input of a size; a stitch material module for input of a stitch material to be used; a calculation module configured to automatically calculate a grid-based template based on the determined style, size and stitch material; and an output module configured to output the grid-based template to a user as a design for the stitched object.

In a particular case, the calculation module may be configured to calculate a grid-based template by determining a base template for the determined style, apply the determined size to the template to produce a sized template, and apply a property of the determined stitched material to the sized template to produce the grid-based template.

In this case, the system may further include: a pattern module for input of a pattern and the calculating module may be configured to calculate the grid-based template also based on the determined pattern. In this case, the calculating module may be configured to designate the grid-based template a material-specific template and may apply the pattern to the material-specific template to produce the grid-based template.

In an alternative or in addition, the system may further include: a user gauge module for determining a user gauge and the calculating nodule may be configured to calculate the grid-based template also based on the user gauge. In this case, the calculating module may be configured to designate the grid-based template a material-specific template and may apply the user gauge to the material-specific template to produce the grid-based template.

According to yet another aspect, there is provided a system for designing a stitched object, the system including: a receiving module configured to receive a grid-based template for the object; a gauge module configured to receive a new gauge for the object; a calculating module configured to automatically calculate a new grid-based template for the object; and an output module configured to output the new grid-based template to a user as a design for the stitched object.

According to yet another aspect, there is provided a physical computer readable medium containing instructions for designing a stitched object, which when executed on a computer, cause the computer to perform the method of: determining a style; determining a size; determining a stitch material; automatically calculating a grid-based template based on the determined style, size and stitch material; and outputting the grid-based template to a user as a design for the stitched object.

According to still yet another aspect, there is provided a physical computer readable medium containing instructions for designing a stitched object, which when executed on a computer, cause the computer to perform the method of: receiving a grid-based template for the object; receiving a new gauge for the object; automatically calculating a new grid-based template for the object; and outputting the new grid-based template to a user as a design for the stitched object.

According to still yet another aspect, there is provided a method for designing a stitched object, the method including: determining a style; determining a size; determining a stitch material; determining a pattern; determining a user gauge; automatically calculating a grid-based template based on the determined style, size, stitch material, pattern, and user gauge; and outputting the grid-based template to a user as a design for the stitched object.

Various exemplary embodiments of the system and method of designing and rendering stitched objects are described herein, each of which is provided as a non-limiting example.

### FIGURES

The drawings included herewith are for illustrating various examples of articles, methods, and apparatuses of the present specification and are not intended to limit the scope of what is taught in any way. In the drawings:

FIG. 1A is a schematic drawing of a garment model;

FIG. 1B is a schematic drawing of the garment model of FIG. 1 showing points;

FIG. 1C is a schematic drawing of the garment model of FIG. 1 showing point transforms;

FIG. 2 is a schematic drawing of a general process of stitched object design;

FIG. 3 is a schematic drawing of a general process of stitched object design;

FIG. 4 is a schematic drawing of a general process of stitched object design involving a two level hierarchy;

FIG. 5 shows a projects screen;

FIG. 6 shows a style screen;

FIG. 7 shows a sizing screen;

FIG. 8 shows a yarn screen;

FIG. 9 shows a motifs screen;

FIG. 10 shows a designs screen;

FIG. 11 shows a design tool window;

FIG. 12 shows an instructions screen;

FIG. 13 shows a gauge input window;

FIG. 14 shows a gauge input window with data entered;

FIG. 15 shows a yarn selection screen;

FIG. 16 illustrates application of colors to a design;

FIG. 17 illustrates application of colors to a design;

FIG. 18 shows a yarn swatch to be rendered;

FIG. 19 illustrates alpha blending;

FIG. 20 illustrates selection of items on screens;

FIG. 21 illustrates interface components;

FIG. 22 illustrates the general layout of screens in this embodiment;

FIG. 23 shows a style screen;

FIG. 24 shows a yarn screen;

FIG. 25 shows a yarn screen with yarn description;

FIG. 26 shows a sizing screen;

FIG. 27 shows a motifs screen;

FIG. 28 shows a colors screen;

FIG. 29 shows example pattern tools;

FIG. 30 shows a knit screen;

FIG. 31 shows a gauge input window;

FIG. 32 shows a projects screen;

FIG. 33A shows a yarn basket window;

FIG. 33B shows a yarn basket window on motif screen;

FIG. 33C shows a yarn basket window on color screen;

FIG. 34A shows a motifs basket window;

FIG. 34B shows a motifs basket window on color screen;

FIG. 35A shows a motif painter window;

FIG. 35B shows a motif painter window on color screen;

FIG. 36A illustrates a garment at a first gauge;

FIG. 36B illustrates the garment of FIG. 36A after a gauge change to a second gauge;

FIG. 37A illustrates a garment at a first gauge;

FIG. 37B illustrates the garment of FIG. 36A after a pattern change;

FIG. 38 illustrates a garment with multiple stitch types forming a motif;

FIG. 39 illustrates a sub-template on a base template;

FIG. 40 illustrates a motif having transparent portions; and

FIG. 41 is a flow chart illustrating a gauge change procedure.

### DESCRIPTION

Numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein. The embodiments described herein are not intended to be limited to the specific details of any one example embodiment or to specific details that may be common to multiple, or all, example embodiments. The applicants, inventors or owners reserve all rights that they may have in any embodiments disclosed herein, for example the right to embodiments claimed in a continuing application, and do not intend to abandon, disclaim or dedicate to the public any such embodiments by disclosure of this document.

Throughout this application, reference will be made to knitting and garments such as sweaters. However, it will be appreciated by one of skill in the art that the methods of systems described herein can equally be applied to other stitched objects that use a grid based system.

Hand-knitting and needlepoint instructions in the past were created by hand, with an experienced designer using specialized trade knowledge and intelligent heuristics. This application relates to a model for the creation of grid-based stitched to objects without the need for expert knowledge. For example, this may include a model of a sweater, a method of sizing a sweater (manipulating the model), and a method of incorporating motifs into the sweater and a method for generating detailed instructions are needed, as well as a system that incorporates these features.

According to some embodiments there is provided a model of a garment pattern (e.g. sweater garment pattern). Further embodiments include a business process for garment creation at the user level, related to the interactive process of creating a garment.

In the following, two interrelated processes are described. The first is the generation of a model or template of a garment that can be manipulated mathematically, and the second is a workflow method of interactive garment creation. The model provides a base for the workflow method to exist (e.g. the mathematical model allows for sizing, etc.) and the workflow method drives input to the model towards creation of a garment (e.g. as gauge is modified by the user interactively, the model adapts and updates itself to create a realistic garment).

### Method of Modeling a Garment

In order to allow a user to design a garment according to a range of sizes and change a garment size in an automatic manner an internal model of a garment (based on a mathematical model) has been developed. Further, a system and method for sizing a garment (by manipulating the model) is provided. This system and method also allows for methods of taking variables, such as yarns and motifs, as input to the model.

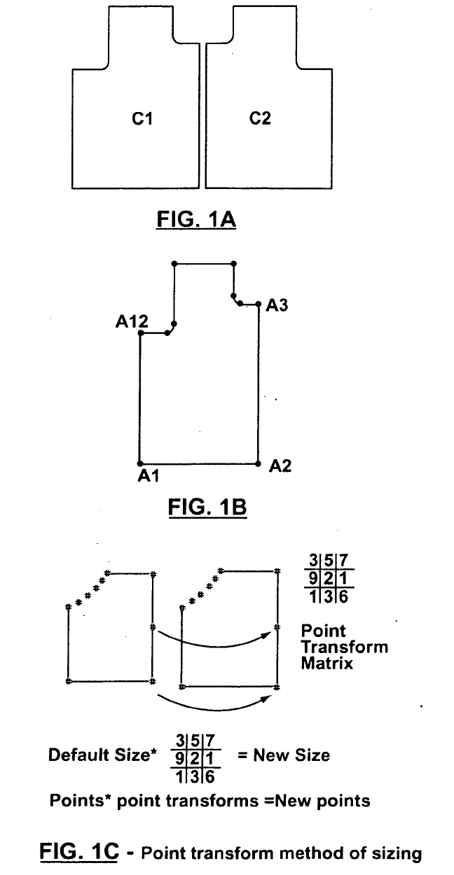

One embodiment involves a component model of a garment or style (e.g. a sweater). Each style of garment is generally composed by a predefined number of major components [front, back, sleeve, etc]. Because some of these components are symmetrical, it may be enough to calculate the dimensions of one component that can then be rotated, flipped or translated to compose any symmetrical components. As an example, in order to calculate the whole component presented in FIG. 1A, it is enough to calculate C1 or C2. These components of a garment can also be called templates.

In modeling a garment, a point model of shape and a grid-based template can be used. For irregular shapes, the greater the number of points, the greater will be the accuracy of any calculations (see FIG. 1B).

This embodiment makes use of a point transformation method of sizing that can be applied to the shape. Each shape will have a grid-based template and list of points associated with it. Each point will have coordinates and these coordinates are using the selected metric. For example, if the chosen metric is US (inches) then each point will have the coordinates represented in inches.

As a notation, we can represent the point Ak as follows:

Aₖ(x,y)=[10,30]

Given a list of points [A₁, A₂ . . . Aₖ], if we want to calculate another size Sₚ from the same class C, we can apply the following transformation:

[A₁,A₂ . . . Aₖ]Sₚ=T(C,Sp,[A₁,A₂ . . . Aₖ]Sₒ)

Where T(C, Sp, Aₖ) is a stored value; C represents transformation factors for the class; Sₚ is the new size; Sₒ is the old size; and Aₖ represents points for the respective size. This general method of using a point transform matrix is illustrated in FIG. 1C.

The method of calculating transforms depends on the component. For example, a v-neck raglan sweater has a different transform at the shoulder as compared to a crew neck set-in sleeve sweater. Transforms for points (T) depend on numerous factors, the way a body changes through size, the specific points involved, the style involved (e.g. raglan) and the amount of ease (loose fit, tight fit). It may also be that internationalization would make it necessary to have different transforms for people in different countries (e.g. Japanese bodies are smaller than Dutch bodies). Various transforms (T) could be provided to allow the garment to be tailored to the individual.

In the model, using a sweater as an example, the style is a combination of the body shape, neck type and shoulder shape. Each part of the style (e.g. body, sleeve, etc.) has a set of equations to reflect the particular style measurements out of the full measurements. Each style also has an associated grid-based template (sometimes called a “base template”) for points relating to the components of the style and output instructions, the numbers of this template are variables.

In the model based on stitched materials, yarn or other materials can also affect the model. Once a yarn is selected as the material; it affects the measurements and the output instructions. In particular, the yarn weight and thickness has an effect on the inner space of a sweater and affects the measurements. This effect/variable is referred to herein as Yarn Ease. Each yarn also has an associated gauge (number of stitches/inch) that impacts the number of stitches and rows in each component of the style.

In adjusting the size of a garment, there are two general key elements: (a) Body measurements and (b) Fit ease.

In a knitted article, the equations are generally:

Full Measurement=Body Measurements+Fit Ease+Yarn Ease

Style Measurements=F (Full Measurements) for each component (e.g. Sleeve, front, etc.)

The style measurements and the yarn gauge generate the number of stitches and rows for each piece. These equations allow for the generation of an electronic grid of stitches and rows (a grid-based template). Each stitch is associated with the yarn chosen by the user. This grid-based template is created according to the variables and can be updated based on changes in variables. In handling different styles, there are specific algorithms to increase or decrease stitches on the piece edge, or create curves for necklines or under arms. In a particular case, the algorithm breaks curves into small diagonal lines and then takes as input the number of stitches to be increased or decreased and the number of rows to be increased or decreased depending on sizing and shape of components. The output will be, for example, the number of stitches per number of rows and the repetition for each decrease/increase (e.g. increase one stitch every 2 rows for 3 times then every 4 rows for 5 times . . . ).

As a particular example, the full cross measurement (which is a function of the style of garment/object) can be calculated as:

Front Cross Measurement(Style)=[Bust Circumference(Body)+Oversize Ease(Fit Ease)+Medium Yarn Ease(Yarn Ease)]/2

In this case, the user has selected “Oversize Ease” and medium “Yarn Ease” for the garment. The variables Oversize Ease and Medium Yarn Ease for Bust Measurements are stored in the database. Based on the front cross measurement, the number of stitches needed can be calculated as:

Front Cross Number of Stitches=Front Cross Measurement×(Gauge(Number of Stitches per4inches))/4

Here, the gauge is calculated using a standard 4 in×4 in swatch of stitched material.

The use of a grid-based template allows for the placement and handling of colors/patterns and motifs. For example, each motif will also have a motif template that can be sized appropriately and overlaid on the base template grid for positioning.

Color is also generally handled on the grid-based template, wherein each cell will be shown on screen by blending its yarn color with a stitch image for the cell. Motifs are handled by replacing the colors of the motifs with colors of the yarns that the user picks, and then mapping the motifs stitches to the base template grid, replacing the yarn associated to the stitches with the yarn from the motifs. The coloring of a motif can be done before or after placement on the base template grid.

Once the model (i.e. the grid-based template) has been adjusted by the user based on variables such as style, size, gauge, and the like, the system and method output instructions and, alternatively or in addition, charts/schematics for the user. For example, with instructions, the system fills the grid-based template with the right numbers based on the previous calculations and the shaping output. With charts, the system creates charts and illustrations based on the grid-based template while schematics are generally drawn based on style measurements.

### Workflow Method of Interactive Garment Creation

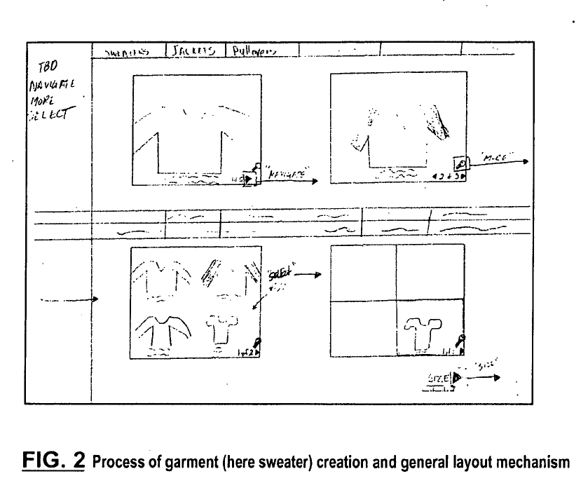

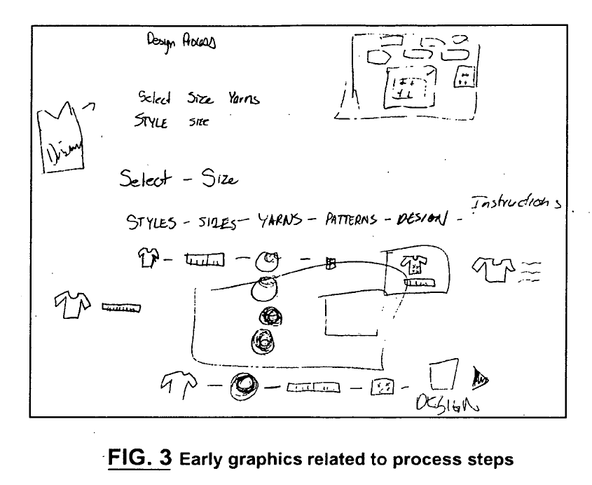

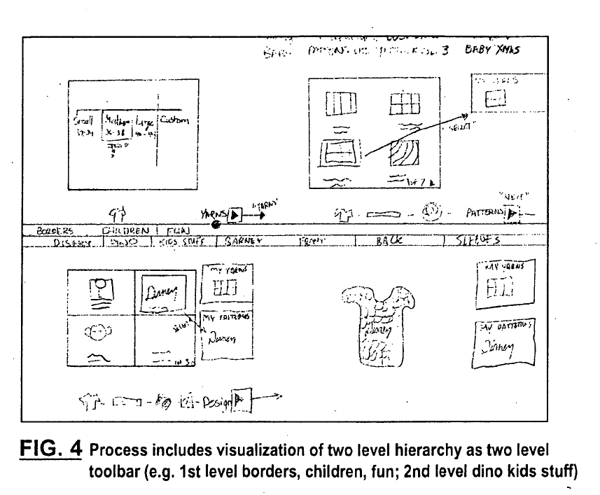

The conceptual workflow process for garment pattern creation includes a process for garment creation broken down into workflow steps, as illustrated in FIGS. 2, 3 and 4. Each workflow step is presented with one/two levels of tabs for organization of items. Some steps are presented as virtual catalogues. Catalogues can be navigated in pages with a means to navigate the items and display of paging items.

When a selection of an item in a catalogue occurs, the next major workflow step is enabled for navigation (e.g. as shown in FIG. 2, once a user has finished choosing a sweater style, the user moves to the size screen. Before the selection of a style (e.g. a v-neck) the size screen is disabled. This reinforces the sequential garment making paradigm).

Some catalogues allow multiple selections, for example, a yarn catalogue allows for multiple yarns to be selected. These can be added into a holding basket and presented in subsequent steps for use in the garment creation workflow.

In an embodiment of the system for garment creation, each screen is organized into toolbars containing a major breakdown of items. This section generally describes the major screens (or workflow steps) in garment creation.

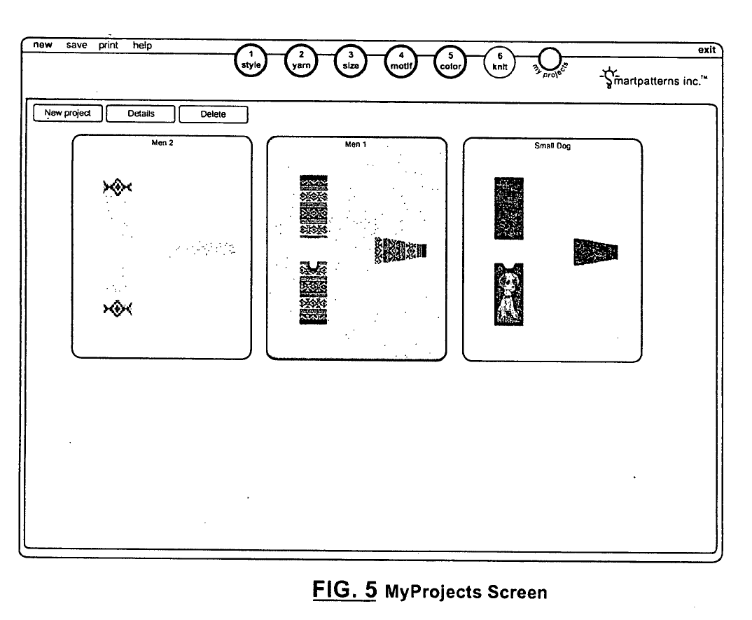

### My Projects Screen (FIG. 5)

The projects screen contains projects the user has worked on which may include projects begun, but not completed. Please note that each of the screens described herein may also be referred to as a module.

Implications on workflow: Garments created or begun but not finalized are automatically added to this section. When a user chooses an existing project, this project is reintroduced into the garment creation process from wherever the user left off (e.g. if the user had selected yarns and saved the project, the user would be reintroduced to the yarn screen).

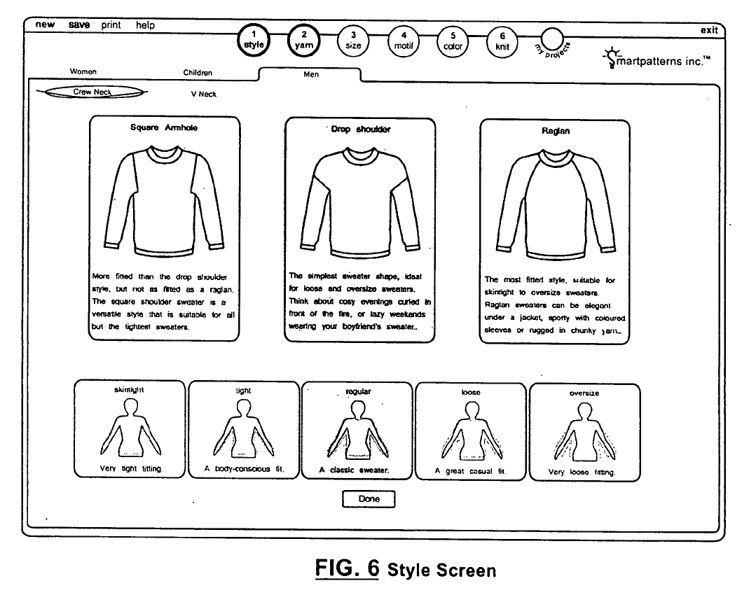

### Style Screen (FIG. 6)

1st level toolbar—Major groups—There may be 4 1st level items, Women, Men, Children, My Gallery. 2nd level toolbar—Style families—There may be quite a number of 2nd level groups.

Implications on workflow: Garment creation process in this screen is broken down into a choice of sex first, and style types second (e.g. sweaters, cardigans). Alternatively, the second level could be more specific style types (e.g. vnecks, crew necks) with a subsequent catalogue presentation of various subtypes.

Styles may be downloaded into the application or chosen from a list or uploaded if a web based application.

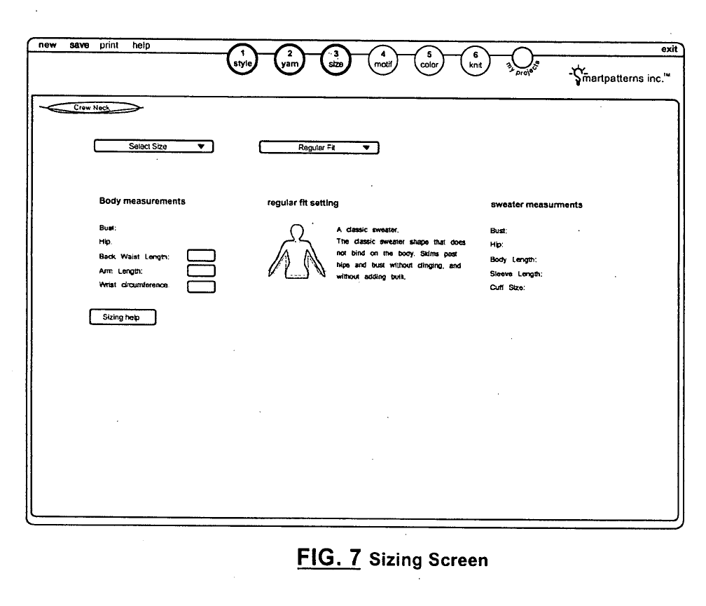

### Sizing Screen (FIG. 7)

There are two potential workflows for the next step Yarn or Custom. Implications on workflow: The sizing screen in the process allows for body measurements to guide the creation of the garment. For sweater creation, for example, the chest width could be presented as the main determinant from which the appropriate body measurements are triggered and garment sizing is created. Different from most patterns which come in a fixed size (e.g. S,M,L), here, the size an be selected with more specificity and the pattern is custom created to the selected size.

For more custom sizing, finer modifications may be allowed to certain object properties. The custom sizing workflow would override any normal sizing elements. For example, if a chest width of 32 inches was selected this may trigger a sleeve length of 31 inches. If during custom sizing, the sleeve length was editable and changed to 30 inches this would override. The garment pattern would be automatically modified to this new size.

Body sizes could be saved as could the finished garment size, for example, either online or on the hard drive, for future use. Future patterns could then automatically be transformed into this size.

In some embodiments, the size e.g. bust 52 can be saved with a given name allowing for privacy.

Ethnic, Geographic size default size tables may be downloaded/added.

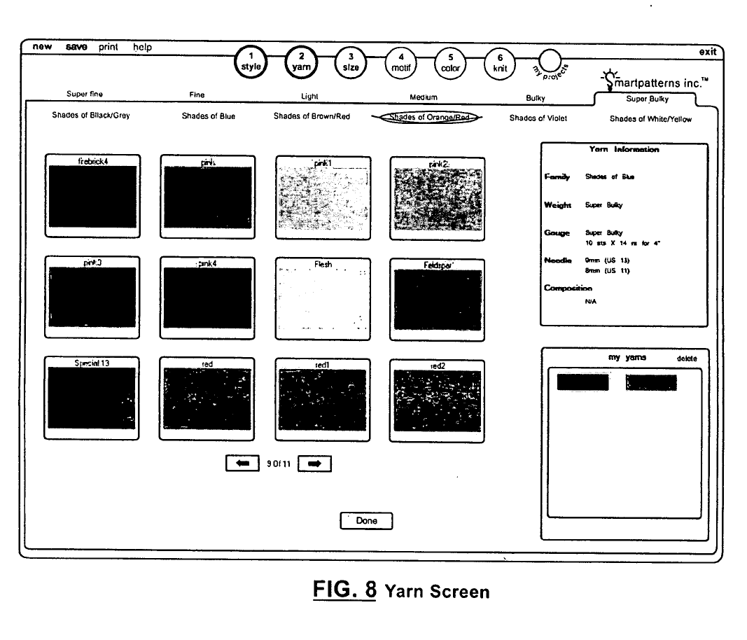

### Yarn Screen (FIG. 8)

1st level toolbar—Yarn weight—There may be a selection of yarn weights. 2nd level toolbar—Yarn family—Selection of families per yarn weight (for example 2-5). These families would typically be the names of the yarns used by the Manufacturer . . . . Each family such as “Canadiana” can have many yarns (e.g. 15-20)

Implications on workflow: Garment creation process in this screen is broken down into a choice of yarn. When a yarn is selected it can be added to a My Yarns basket to be used in subsequent steps of the workflow.

In this embodiment, the organization of yarns is first by yarn weight. The defined 1st level can come from the standard published by the yarn council of America (e.g. Super fine, Fine, Light, Medium, Bulky, Super Bulky) or the breakdown can be more proprietary (e.g. 1) Sock, Fingering baby 2) Sport, Baby 3) DK, Light Worsted 4) Worsted, Agfhan, Aran 5) Chunky, Craft, Rug 6) Bulky, Roving). These breakdowns may be variable based on a particular culture taking into account different concepts of yarn weights.

The second level breaks down yarns into a set of families. All the yarn families are approximately the same weight and so fall into one of the 1-6 categories defined by level one. Within a family the yarn properties are the same (material makeup and gauge) but the dye colours differ.

Yarn Co. can create pallets that can be incorporated into the software so new yarn collections can be added.

Users can enter their yarn inventory and the program will use their yarns and recommend projects that require approximately the yard they have.

Motifs can be downloaded into the application.

The Motif can be recoloured by double clicking on it and using a “paint application’ with the selected yarns appearing as options for colors. The yarn colours can be applied to the motif.

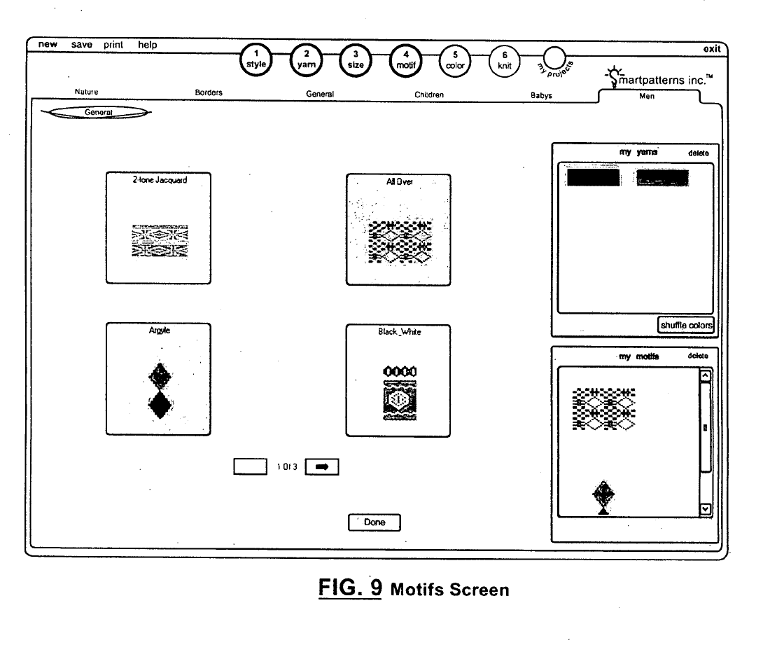

### Motifs Screen (FIG. 9

1st level toolbar—Major groups—In an embodiment there may be 3-4 major groups. 2nd level toolbar—Sub groups—Sub groups are items that have been place in a major group. For example, a major group such as Small Stuff could include “Geometrics”, “Mazes” etc. . . . that is small. Normally 2-3 sub groups.

Implications on workflow: Garment creation process in this screen is broken down into a choice of motifs. When a motif is selected it is added to the My Motifs basket for use in subsequent steps of the workflow.

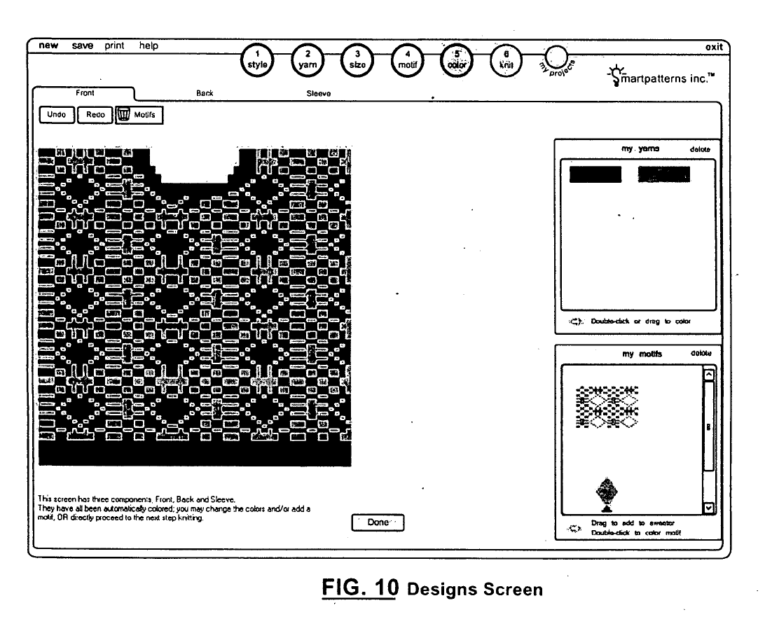

### Design Screen (FIG. 10)

1st level toolbar—Front, back, side. Design screen is where the design comes together. The drag and drop is used to place patterns (including stitch patterns, motifs, color patterns and the like). A pattern dynamically shows the actions that can be taken on it, so a toolbar may not be needed. Yarns are drag and dropped to the main design. Motifs are single clicked or drag and dropped on to the main design. Motifs can be “active” and, while active, tools can be applied to them

Implications on workflow: Garment creation process in this screen is broken down into the combination of a style, various yarns, and various motifs. A piece of garment, for example, the front of the sweater is made with a combination of yarns and motifs. The presentation of the garment in terms of visualization is of a number of stitches and rows, with some shaping based on the style (e.g. the curve of the crew neck). The number of stitches is not fixed, but a function of the size (with any custom adjustments) and the yarn(s) selected. In this way a pattern is dynamic, and the visualization of the pattern is dynamic as well. The design screen would preferably show the number of stitches on screen in a simulated way (e.g. if there 40 stitches in a row in the underlying “model” or grid-based template, then 40 stitches could be visualized).

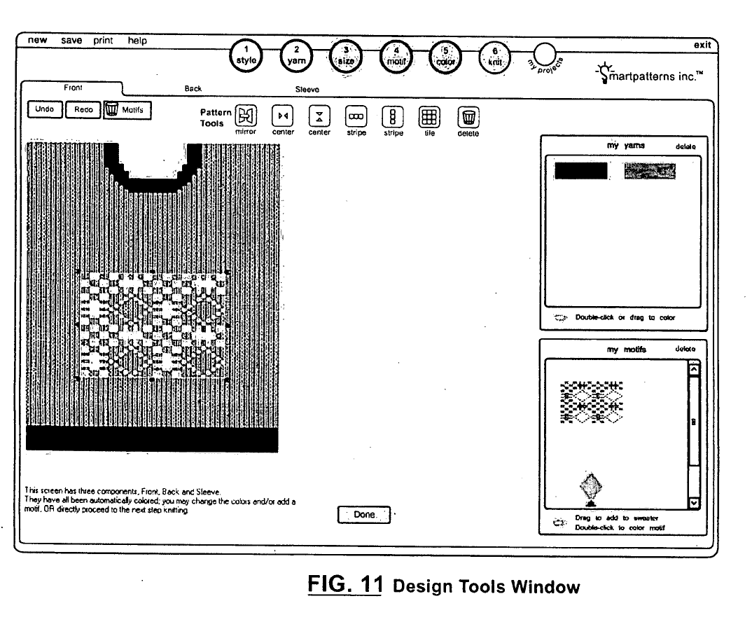

In the process of garment creation, a motif can be moved or manipulated. When “active” a motif can be highlighted and a Design tools window can be shown to allow manipulation of the motif (see FIG. 11). The tools may include:

Maximize pattern—maximize motif to a size that is acceptable and doesn't change the gauge

Minimize pattern—minimize motif to a size that is acceptable and doesn't change the gauge

Duplicate pattern—make a copy of the motif

Mirror pattern—flip the motif

Center horizontal—center the motif on the sweater

Center vertical—center the motif on the sweater vertically

Delete—delete the motif

Other tools such as rotation, and tiling horizontally (repetition) or tiling vertically (repetition), or a tiling all over may also be provided. In general, the process allows for interactive manipulation of patterns by making them active and using tools. When non-active, the tools window is not shown.

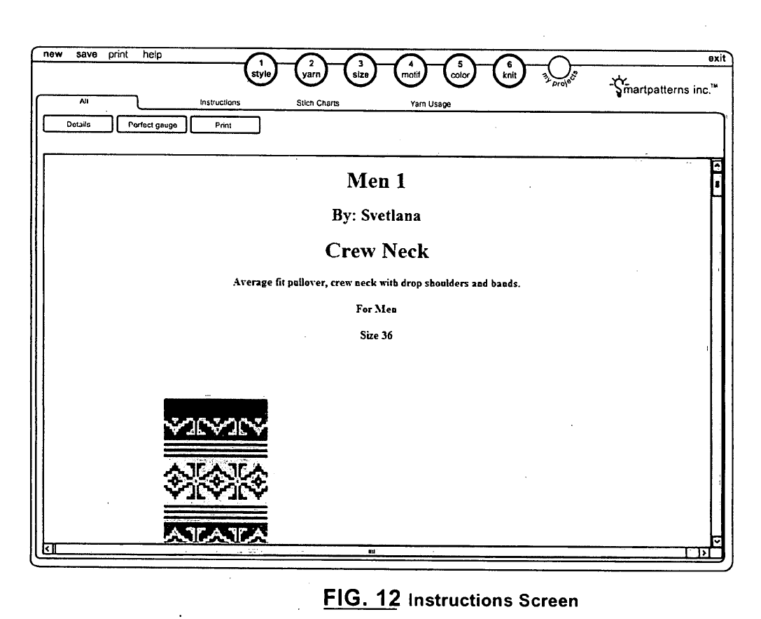

### Instructions Screen (FIG. 12)

1st level toolbar—Coverpage, Instructions, Stitch Charts, Yarn Usage. 2nd level toolbar—Functions, Print, Save, Gauge Change

Implications on workflow: The system gathers all the elements of the style, sizing, yarns, motifs, and their application on a design and applies these variables to an internal model of the garment. In particular, after a user has selected a style, the system determines a base template for that style from a database of templates. After the user selects or inputs the size, the system applies the selected size to the base template using transform calculations of the type described above to provide a sized template. The system then applies the selected yarn(s) and patterns to the sized template to produce a material-specific sized template. The system then uses the material-specific sized template to generate instructions to describe how to make the object (garment). It will be understood that the determination of the base template and application of the size to the base template may also occur at earlier stages of the process, for example, at the style screen or size screen based on input by the user.

The generated instructions may be textual, visual, charts, or any of various types of instructions as known in the art. The system may also generate visual graphics to show visually how to make the garment. The instructions may break up the description into components of the garment, with descriptions of how to attach components together. The instructions may be output to a display screen, printer, or the like.

At this stage, the garment creation process is complete, and this screen shows the result of the previous workflows as the completed garment with instructions. The breakdown of instructions may preferably be into functional groups for the purposes of either seeing one part of the instructions (e.g. some users will use stitch charts to create the garment, some will use written instructions).

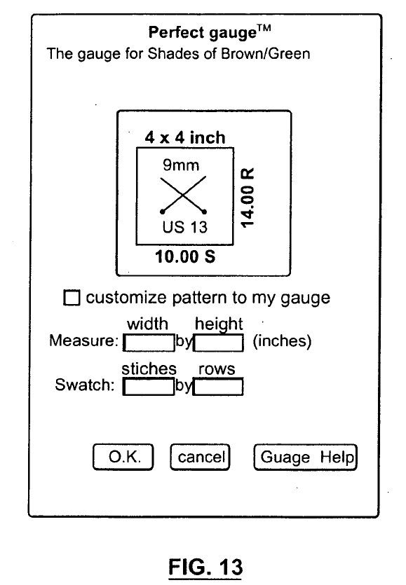

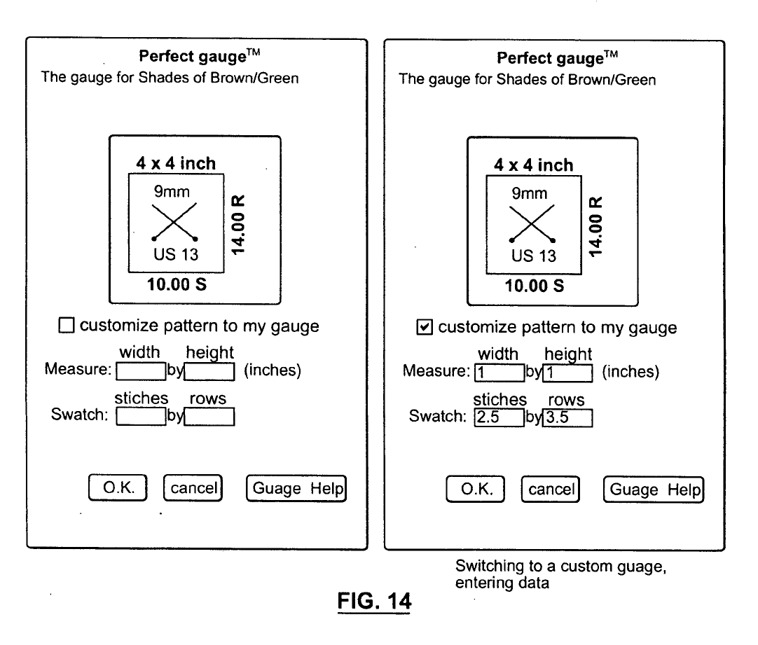

This screen may also provide a function to allow a gauge change (as shown in FIGS. 13 and 14). This unique ability in the workflow allows a user to modify a pattern to their own gauge. For example, if the user is getting 20 stitches/inch instead of 25 stitches/inch because they knit looser than average, they can update the output based on their own gauge. The system adapts the grid-based template to the user's actual method of knitting. This function is rather unique in that typical instructions, digital or analogue, up to now have been fixed and require a user to achieve the intended gauge on their own. Adjustment of the gauge is described in further detail below.

### General Procedures/Interactions of Elements

The general interaction design elements within the interactive garment creation process may include various features.

For example, the workflow can be broken down to a step-by-step process. The presentation of a screen (e.g. style screen) with one or two level of toolbars allows for faster browsing. Two major hierarchies of “selection” within a step can be presented.

Within screens or levels, a simple selection mechanism can be used. For example, a single click addition mechanism for choosing a sweater, a yarn or a pattern. This can lead to instant addition to the My Yarns or My patterns list and may include a single click removal mechanism when a selected yarn or pattern is clicked again.

The means of selection (e.g. using a mouse) of an item within a step of the process also allows the user to continue the garment creation process; for example, selecting one on more yarns which are added to a My Yarns bin, for use further on in the process.

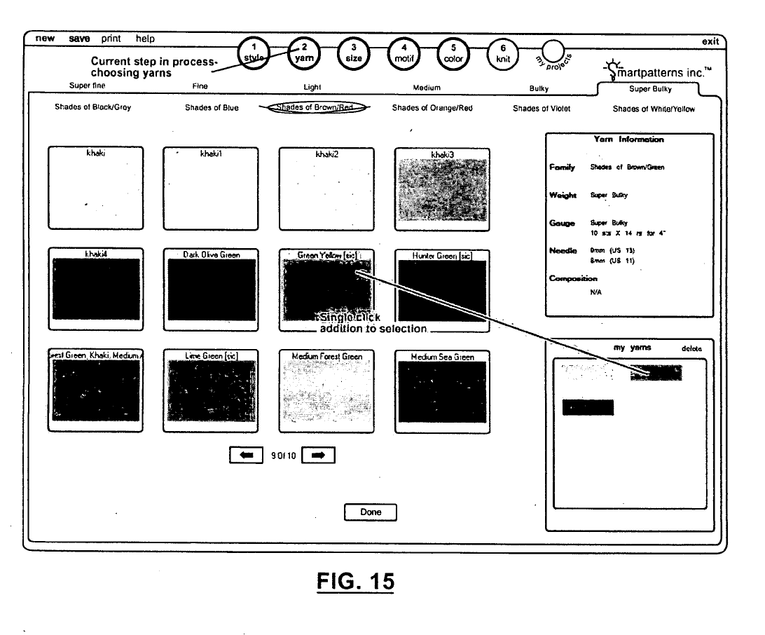

In some embodiments, as shown in FIG. 15, the process may include disabling the “next-step” in a process, before a selection has taken place by the user. Until “yarns” are selected, adding “motifs” cannot be done. Similarly, the behavior of post-selection visual enabling of the next step of the process to the user (e.g. after selection of a yarn the “pattern screen” is enabled).

In some embodiments, workflow between many steps or across steps may include sticky memory—the concept of keeping the user on the screen they are on in a previous session, and a means to navigate between workflow steps.

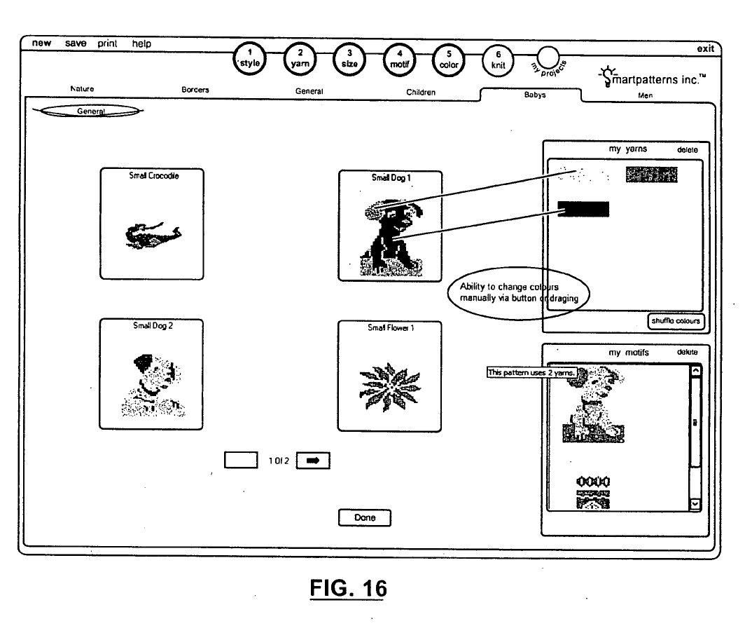

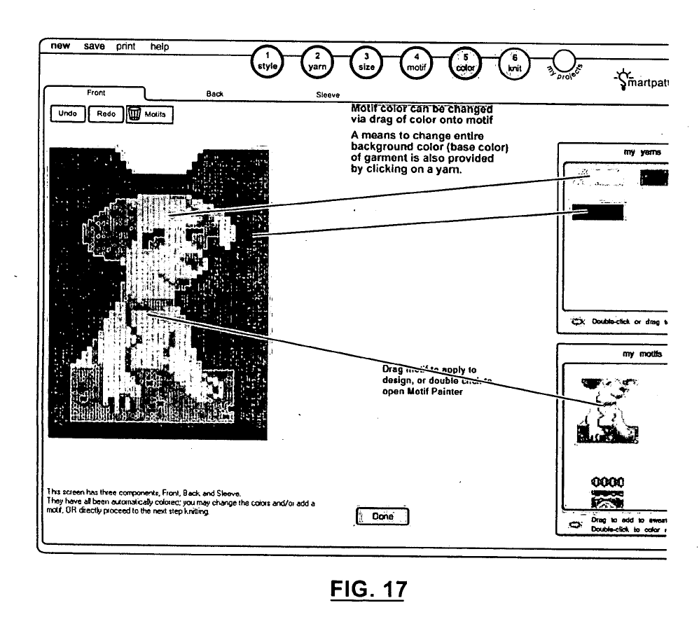

In some embodiments, as illustrated in FIGS. 16 and 17, the garment creation workflow includes automated features such as: automated application of the first yarn in the selected yarn list to a piece of the garment (so user doesn't need to select); automated application of yarn to motif patterns and a method to manually change color of yarn; single click application of pattern to design (so user doesn't need to drag).

The method of manually applying yarn may include an interactive drag and drop coloring of yarn onto pattern. The drag of the yarn onto a pattern on the sweater would interactively and automatically swap all equivalent colors on the pattern, with the dragged yarn. For example, if dragging a blue yarn onto a red and white stop sign pattern/motif, if the user has dragged over the red part, all red in the stop sign would be show blue, and the white would be preserved; in the same action if the user moves over the white of the stop sign, the software would interactively show a stop sign with all white replaced with blue, and the red preserved. If the user cancels the action by moving the dragged item away from the pattern and stopping the drag, no swap action will take place. If the user had let go of the blue yarn over the red in the stop sign, the blue would permanently replace the red in the stop sign.

### Method for Yarn Rendering

This section describes a method for rendering a stitched material that is intended to provide a realistic representation on a display screen, using, for example, alpha blending. The example provided is for yarn but the method can apply for other materials. While making sweater patterns in software can be fun, it is not always possible to accurately visualize the finished product. Yarn is attractive to view, people like interacting with it. Yarn companies want their yarn accurately depicted. Standard technology generally does not digitally show yarn swatches in order to incorporate them into sweater designs.

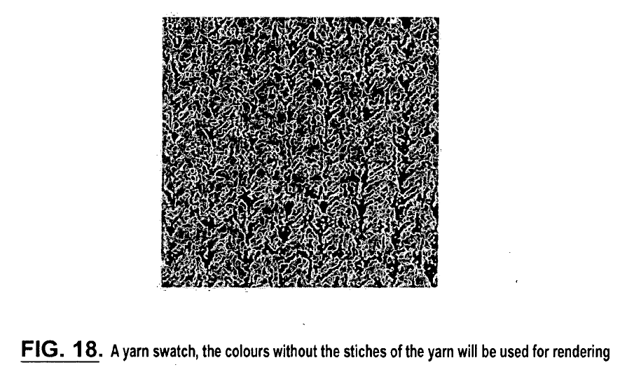

A single color cannot simulate a yarn texture. We must be able to take samples of yarn from Yarn Companies and digitize them. Our analysis has shown that a yarn swatch can have over 80 shades of a single colour when seen in a single white light source—this gives it the life-like look (FIG. 18).

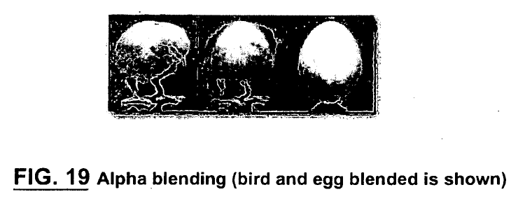

To realistically simulate a texture with a changing color surface (yarn), alpha blending may be a technique (from computer graphics) that can be used. Colour must be retained from yarn, while the stitch is a dynamically changing graphic based on stitch gauge. Alpha blending is a common technique for graphical simulation and an example is illustrated in FIG. 19. This technique may affect color channels (color shifts, lightening possible).

Method of histogram equalization for the method of selection of the most common yarn color from a sample:
1. A set of n point samples of a photograph of yarn are taken. The pixel value of each point sample is a single color.
2. The n samples are put into bins of color space. The greatest number of samples in a bin leads to the most common yarn color.
3. To avoid color repetition and (Black & Gray Problems) the color is considered as new and added it to bin when it is shifted with an appropriate margin from the other colors.
4. For a single color yarn, taking the most common yarn color ensures that we don't use black, which constitutes a major part of the yarn graphic.

Method of blending yarn samples with stitch elements to generate realistic yarn visualization:
1. A set of n point samples of a photograph of yarn are taken. The pixel value of each point sample is a single color.
2. A stitch in the yarn visualization calculated to be a certain size, for example, 5 pixels by 5 pixels. A sample 5×5 is taken from the point samples.
3. The yarn sample above is blended with a stitch graphic, which provides the textured realistic “look” of a real stitch. The yarn sample provides the colour, and the stitch the texture.
4. Step 2 and 3 are continued for each stitch, thereby slightly varying the stitches and making them look all the more realistic.

Method of visualizing multicolor yarn:
1. The vertical space of a photograph of yarn is divided to m areas, where m is the number of distinct colors the yarn possesses.
2. m sets of n point samples of a photograph of yarn are taken.
3 Each set is of n samples is blended with a stitch graphic.
4. As the rendering moves through the stitches, we move from color to color to simulate the changing yarn.

It should be understood that various modifications can be made to the exemplary embodiments of rendering as described and illustrated herein, without departing from the general scope of the methods presented.

### Additional Detail for Interactive Garment Creation Process

The following description provides a more detailed embodiment of a system and method for garment design.

The following system provides a method for a user to interact with a set of galleries so that the user can quickly and easily customize a garment style to their preference.

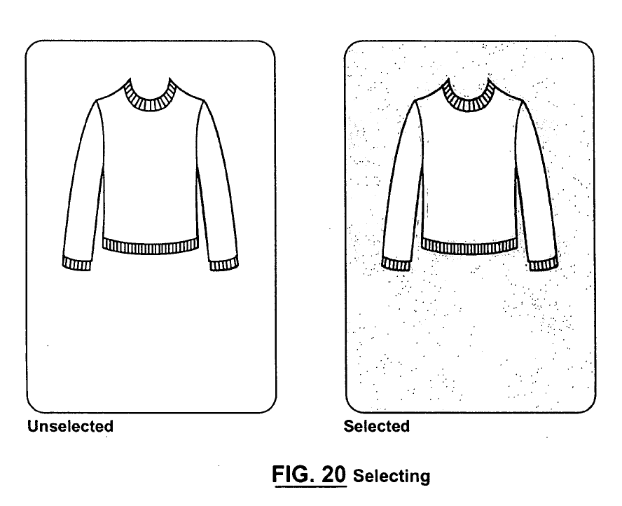

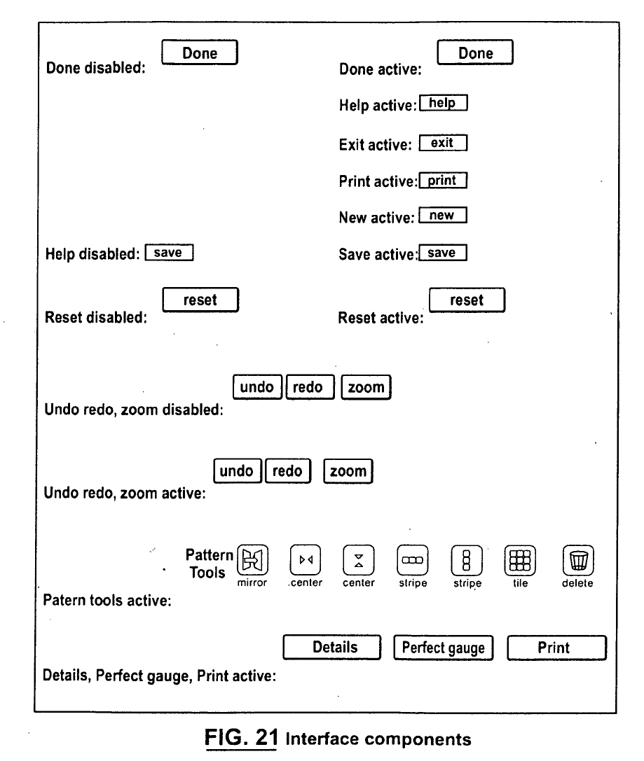

Initially, there are a number of items that apply throughout the garment design process. Selection is the manner of choosing an item in a gallery, illustrated in FIG. 20. Throughout our application, selection is typically a single click-process. Launching is the manner of “opening” an item. For example, double clicking a motif in the motif gallery can open the Motif painters. On many screens there are buttons that may be active or disabled. For example, a “Done” button may be initially disabled but made active when all selection tasks on a screen are done. When a user hits the done button, he or she can be taken to the next screen. Examples of buttons are shown in FIG. 21.

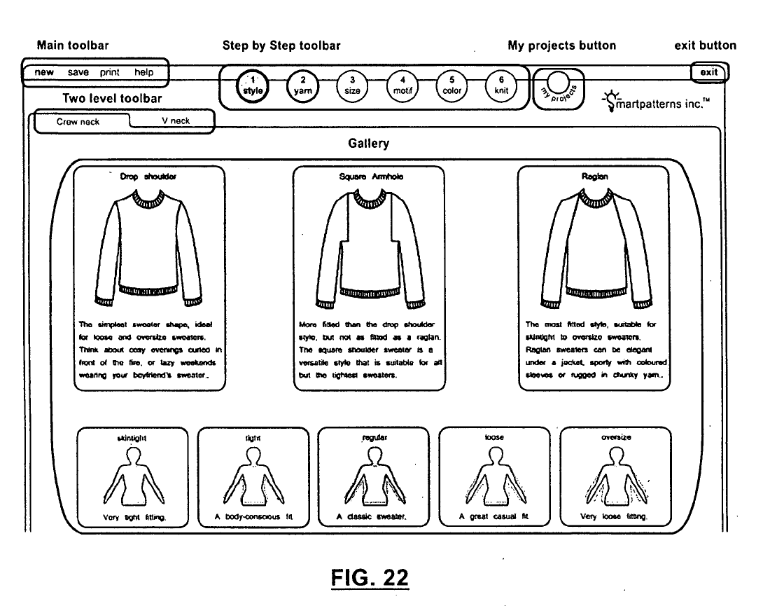

The general layout of entry screens according to one embodiment is shown in FIG. 22. The elements of the screen are:
Main toolbar—application level functions for projects
Exit button—application level exit
Step-by-step toolbar—walks through the various screens of the sweater making process
Two-level toolbar—the subcategories of items within a screen
Gallery the place where items to be selected are stored

In the main toolbar, the application level functions are New, Save, Print, and Help.
New—Single state button. This begins a new project. If a project was under way, a dialog asking the user if he would like to save is displayed.
Save—Dual state button (active and disabled). This button saves the current project. When pressed, the “Details” dialog is displayed allowing the user to customize the designer's name and the project description. Enabled when a project reaches the size screen after yarn selection (and choose style).
Print—Single state button. Prints the entire screen as a screen capture.
Help—Single state button. Launches help for the active screen.

In the step-by-step toolbar, a user is provided with a guide through the process of making a sweater screen by screen—each screen is a step. The toolbar operates on the principle of progressive activation of steps. As the user completes a step, the next step is made active.

Each step has 4 potential states that can be illustrated by the display of that step in the step-by-step toolbar. For example, an active (the one you are on) step may be colored accordingly or brighter than others or the like. A disabled (you can't go there yet) step may be grayed out and duller than the other steps. Similarly, an enabled (you've been here already) or you can go there but it's not next (yarn, size) may be a different color or less bright or the like. Lastly, the next step (the one you are ready to go to) may be highlighted in some way, for example by providing a colored exterior element or the like.

When a garment is first created there is preferably a fixed sequencing of steps. In some cases, the user must generally complete each step on each screen. For example, on the size screen they must select a size to use. This is advantageous for beginners in that it teaches them that their interactions lead to progressive enabling of the done button. In other cases, users may be allowed to skip sizing because a “remembered” or “favorite” size is used. In the following workflow, neither motif screen nor color screen need to be mandatory steps.

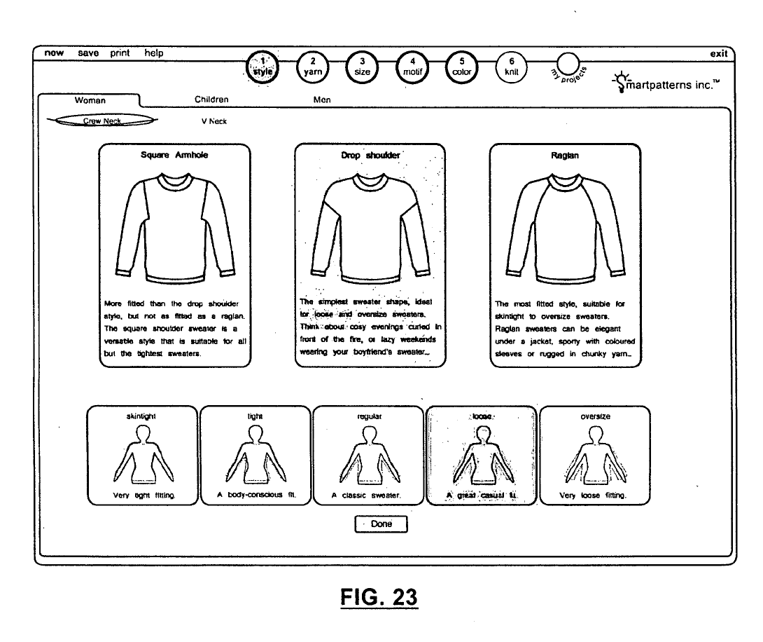

### Style Screen (FIG. 23)

The style screen allows the user to select the style and fit type of the sweater design. In this example, the style screen has a single level of neck type as a tab (crew, V-neck) and underneath that selection the style screen has 3 sweaters in the chosen neck type (3 types are raglan, drop shoulder, square armhole) and 5 fit settings.

For a new project, when a screen is opened, 3 sweaters can be shown with nothing else. A user selects a style setting, and once selected, fit settings appear. The user elects a fit setting, and the done button is activated the next state is activated.

For an old project, when a user navigates to the style screen everything is generally shown and the done button moves from the disabled to active state.

When changing the style for an old project, the chosen shoulder type and the chosen fit type are shown for the project sweater. If the user chooses a new shoulder type, the change is applied. If the user chooses a new fit type, the change is also applied.

When changing styles custom fit modifications are preferably preserved. For example, the behavior of sweater style changes on the size screen is that any custom modifications to the body dimensions are preserved, even though these may not make sense stylistically. For example, if the user added 1 inch to the wrist for a drop shoulder, and then changes to a raglan, one inch will still be added to the wrist.

When changing style motifs, the system tries to keep the motifs in place on the sweater. The behavior of sweater style changes on the color screen is that the system tries to keep the motifs in the same relative positions. If motifs were centered by the user on a drop shoulder sweater, they will be centered on the new raglan sweater as well.

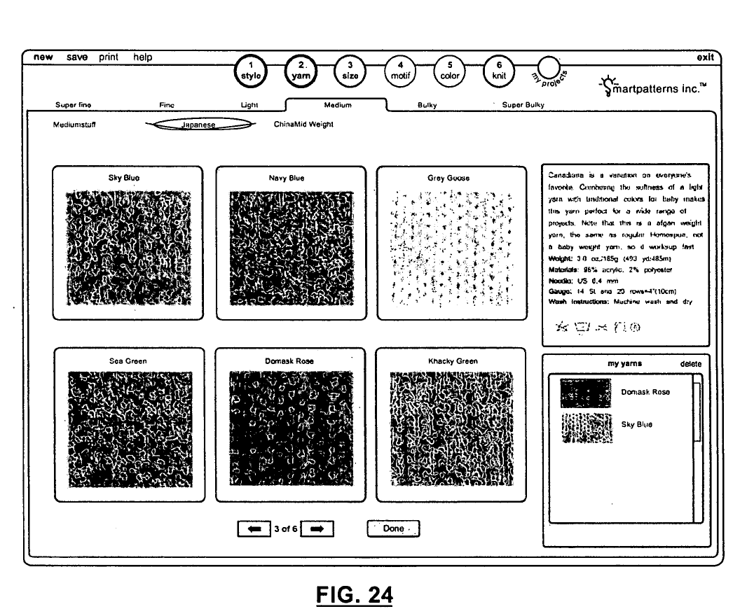

### Yarn Screen (FIG. 24)

The yarn screen allows the user to browse and select yarns to be used in the project. The yarn screen shown has two levels. The first level is broken up into 6 weights types (super fine, fine, light, medium, bulky, super bulky). The second level is broken into families of yarns under the first level—these families depend on yarn manufacturer. In this example, there can be up to 6 yarn families on the 2nd level. If more than 6 yarn families are present in the software an additional yarn level will continue underneath.

The yarn screen shows 6 yarns at once in 2 rows and 3 columns. If the yarn graphics from the yarn manufacturer are smaller than 130×130 pixels, then 8 yarns may be shown at once (2 rows, 4 columns). Preferably, the yarn list shows rendered swatches.

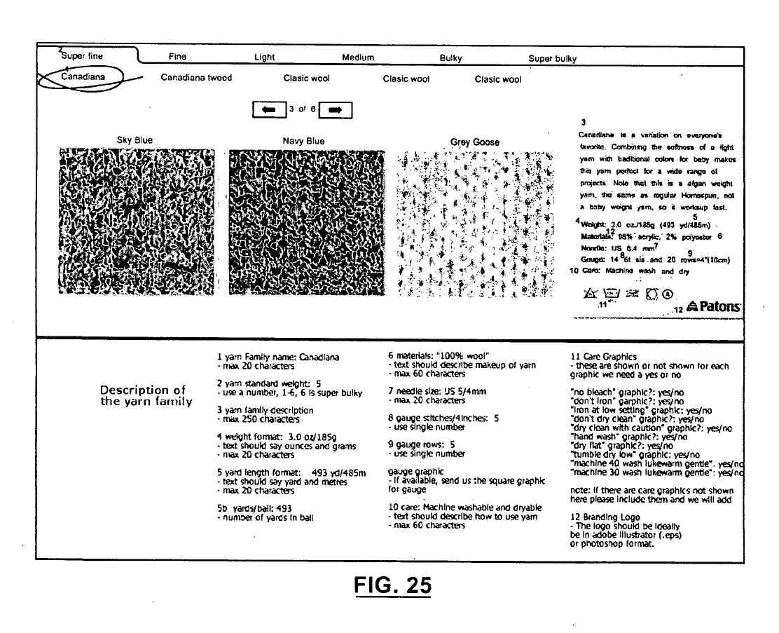

### Yarn Family Info (FIG. 25)

The yarn family info is generally fixed in place and contains 6 fields (see diagram). It is automatically active and always shown because a yarn family is always shown. The lengths of the fields are shown in the demonstration below.

The yarn basket is generally fixed in place and right aligned. More information will be provided about the yarn basket below. The yarn basket contains for each yarn, a mini-swatch of the yarn and a color name. If no swatch is present from a yarn company, then we can use yarn color sample from yarn company with no stitch present. Our goal is to make the yarn look like it does on their website. As per normal selection, clicking a selected swatch in the gallery can add or remove it from the yarn basket.

When first opened, the yarn screen shows the last chosen yarn weight chosen as selected. If this is the first time the program has been opened, a default yarn weight (e.g. super fine yarn) is selected. Similarly, when first opened, the last yarn family chosen is selected again. If the first time, the first yarn family in the selected weight is chosen.

According to some embodiments, selection of yarn from two families may not be allowed. For example, if the user has Canadiana family yarns in the basket and attempts to add yarns from another family, the following dialog message can shown with an OK button:
“So far you've chosen Bulky yarns from Canadiana. You are free to keep browsing other yarns, but please limit subsequent selections to Canadiana. In the future, we will allow multiple yarns to be used with multiple gauges.”

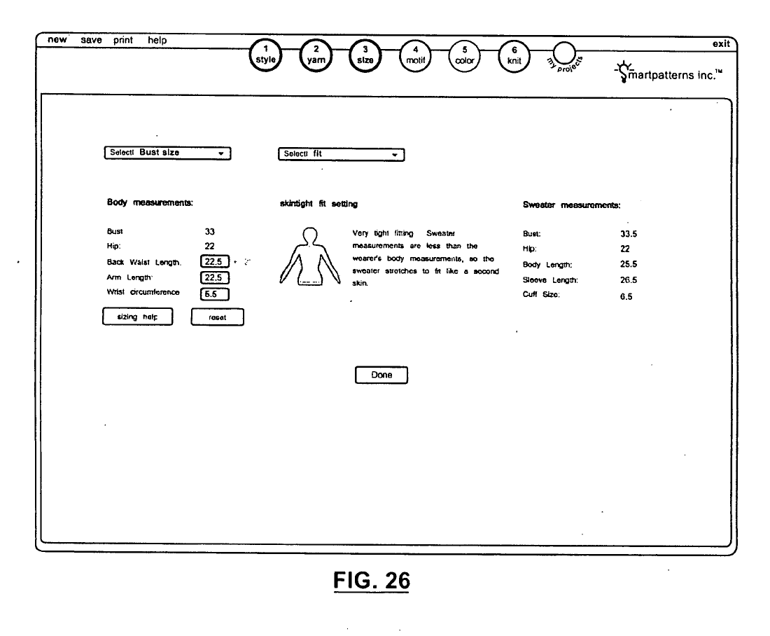

### Sizing Screen (FIG. 26)

The size screen allows the user to customize the size to fit a particular body. The size screen is broken down into two activity areas, 1) customizing to the body and 2) customizing fit. The main determinant of size is the bust setting, the further selection of fit offers refinement.

When the sizing screen is first opened the left pulldown menu indicates “Select Bust size”. The second pulldown menu is set to the fit setting selected on the style screen (e.g. Skintight fit). Preferably, no measurements are shown whatsoever, until the bust size is selected.

After selecting a bust size from the pulldown menu the default body measurements are shown on the left and the sweater measurements are shown on the right side. The sizing help and reset buttons appear after selection of a bust size, as does the done button. Help could be available even before selecting size. Body measurements detail the body measurements for a knitter of the selected bust size.

Generally speaking, the sweater measurements are based on four factors:

the sweater type (e.g. raglan crew neck)

the fit type (e.g. skintight)

the yarn weight (e.g. heavy weight)

the bust size

In this example, the user can edit the following items: the back waist length, arm length, and wrist circumference. Until the user enters a custom length, no deviation text is shown (i.e. “+3 inches”) and no Reset button is shown. Bust and Hip cannot generally be changed.

When body measurements are adapted, the sweater measurements are increased or reduced by the appropriate amounts.

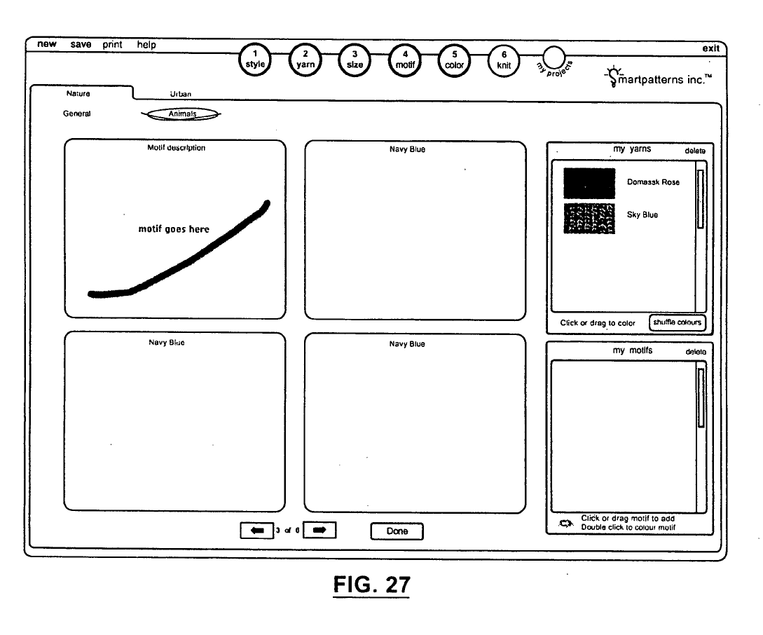

### Motif Screen (FIG. 27)

The motif screen allows the user the ability to browse and select from a collection of motifs to be used in the project. In this embodiment, the motif screen has a single level of organization but further levels can be added. For example, a general category like “Children” or “Adults” could be on the first level. The second level could include subitems of the first, for example, for “Children”, “Dinosaurs”, “Birthday”, “Nursery”, and “Cartoons” could be possible subdivisions.

On entering the motif screen, the motifs may be colored based on the selected yarns. For example, if the user has chosen Blue, Red, and Orange, and the motif has 2 yarns in the pattern, then the first 2 yarns are used (blue, red) to color the motif. In other words, the motifs are automatically colored with the chosen yarns with no user intervention.

The motif gallery has a single click to add and remove from the basket. When the user selects a motif in the gallery, it is highlighted in blue. Clicking the same motif in the gallery again, removes it from the motif basket

On the motif screen, the yarn basket may have a color shuffle button that rotates colors down by one. (1st becomes 2nd, 2nd becomes 3rd, and last becomes first). Hitting the shuffle colors button will recolor the motifs shown on the screen as well.

If the user adds a version of the motif to the basket, and then shuffles colors the same motif (e.g. Canadian flag with red/white yarn) will appear in the gallery with different colors (e.g. Canadian flag with white/orange yarn). The motif in the gallery is not impacted by gallery changes because it is different. The selection highlight is no longer shown on the motif (e.g. white/orange Canadian flag) in the gallery because it is different from the one in the gallery. If the user clicks the white/orange Canadian flag motif in the gallery it can be added to the basket. The user can add two versions of the motif to the basket. (e.g. 2 Canadian flags in the motif basket, with 2 colors).

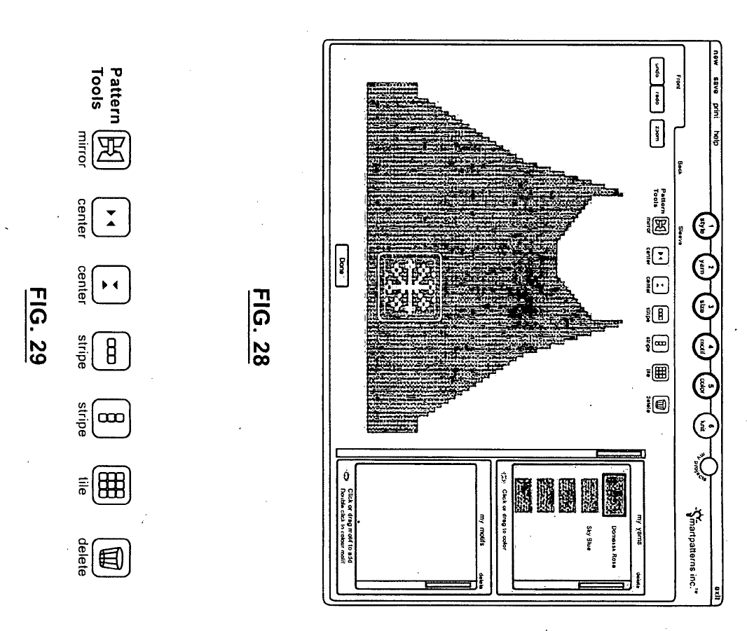

### Color Screen (FIG. 28)

The goal of the user on the color screen is to assemble the yarns and motifs chosen onto the sweater to create a final sweater. The 1st level breakdown of this screen is into component (front, back, sleeve). The 2nd level has buttons for undo redo, and zooming.

When the application is first launched all components are colored with the first yarn in the list. Clicking on a yarn will change the background color for that component (e.g. front of sweater). Dragging a yarn from the yarn basket will color the sweater component or motif depending on where the mouse is released.

Dragging a motif from the motif basket will place the motif on the component, it the motif will not show up because background is same color, we automatically bring up the motif painter.

When a motif is active on the sweater (here the snowflake) the design tools allow you to modify the motif. When a motif is not active on the sweater, the design tools are not shown.

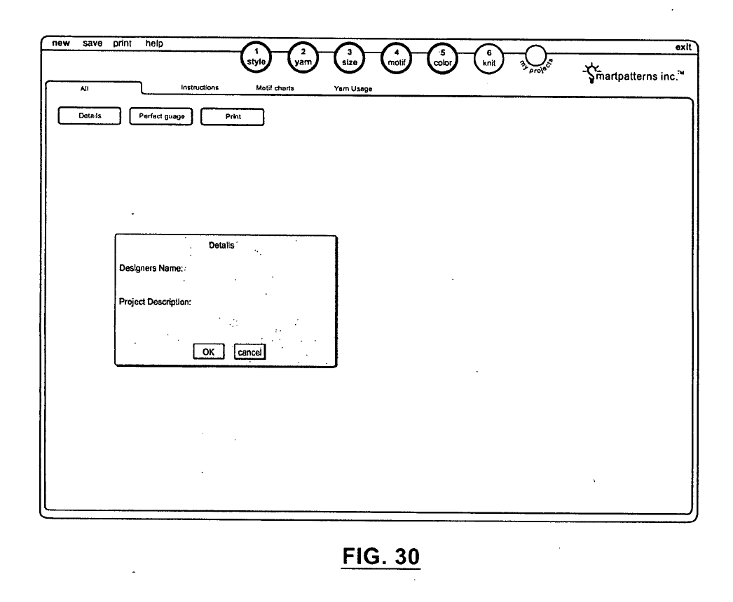

When modifying a motif using the design tools, the normal interaction is click on a motif, then click on the appropriate tool. For example, tools may be as shown in FIG. 29:
Mirror horizontal—flips the motif to create the mirror image
Center horizontal—centers the motif with respect to the width of the sweater.
Center vertical—centers the motif with respect to the height of the sweater.
Stripe horizontal—creates a horizontal tiling of the motif, by repeating it across the sweater
Stripe vertical—creates a vertical tiling of the motif, by repeating it across the sweater
Tile—places the motif all over the component
Delete—removes the motive from the component

The motif can be moved by clicking on it to get a selection marquee, and then dragged with the mouse. The motif will also have handles for resizing at the corners around the motif to allow interactive resize and rearrangement of the motif. In a particular case, all resizing at the corners will keep a fixed aspect ratio (y/x ratio will remain constant).

This screen includes and undo button is initially disabled until an action occurs on the sweater itself. Actions on the sweater result in the undo being made active. If the undo button is clicked, a single action is undone. A redo button is initially disabled until an undo occurs. When an undo occurs, the undone action triggers the redo button to be active. If the redo button is clicked, a single action is redo'd. When the user moves away from the Color screen the undo/redo stack need not be kept and can be cleared out.

Initially the sweater is zoomed out. The zoom button is a single two-state button. Pressing the zoom button zooms the sweater in. Pressing the zoom button again, zooms the sweater out.

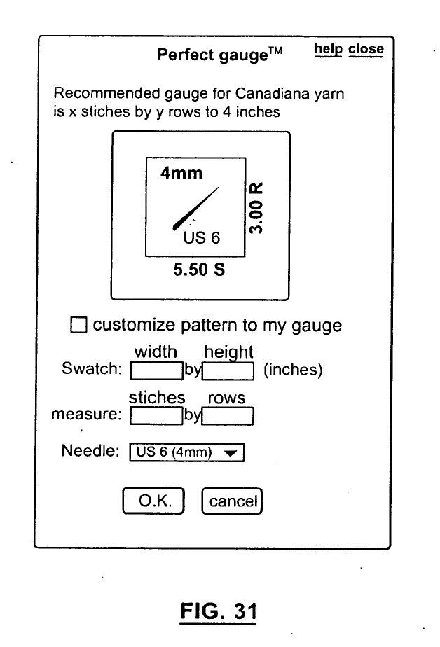

### Knit Screen (FIG. 30)

The knit screen provides the instructions needed to knit a sweater. It is the last screen they use when making a new project.

The breakdown of the Knit screen is into (All, Instructions, Motif Charts, Yarn Usage). Underneath are 2nd level tools common to all Knit screens, the tools are (Details, Perfect Gauge, Print).

The All tab contains:

Title and date (time not needed)

Author (if set)

Brief description—style and ease

Graphic of finished sweater

Yarn usage information

Motif chart(s)

Knitting instructions

The Instructions tab contains same as All, but only the actual knitting instructions. No title, date, author, yarn usage, graphics or motif charts. The Components charts tab contains front, back and sleeve charts. The Motif charts tab contains motifs actually used in the project. The motif charts will be in color. Each motif chart should include a caption that says either ‘intarsia’ or ‘fair isle’ indication

The yarn usage tab helps the user know what yarns they may need to buy to complete the project, and how many balls to buy of each yarn. Two tables are shown, one overview table and one detailed usage table. Yarn overview—contains manufacturer, yarn name, weight, yardage, composition and care information. Yarn usage—contains yarn name, yarn color, and # of balls of yarn

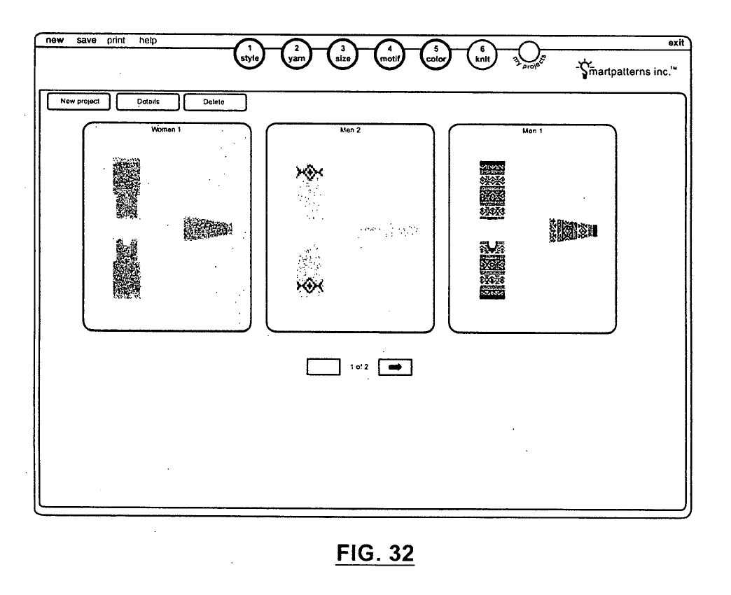

This screen also includes a details button and a gauge dialog. The details button allows the user to customize the name of the designer and the project description. In this case, the designer name can be 40 characters and the project description can be 64 characters but other values can be set. The gauge dialog (see FIG. 31) allows the user to modify the sweater pattern to their appropriate gauge setting. To understand this further, one needs to know that sweaters are typically knit in a specific tension, for example 20 stitches/inch. If the user is not able to achieve the recommended tension because their style is different, or they are using a different needle, we allow the user to tell the system what tension he is achieving and we modify the pattern appropriately. This dialog will show the recommended gauge for the yarn family chosen on the yarn screen as a graphical swatch. The swatch shows the needle size that is recommended in metric (4 mm) and US (6) and the gauge the user is asked to achieve in stitches and rows. For example, 5.5 stitches across 4 inches, and 8 rows make 4 inches.

If the user selects the customize gauge checkbox, the top area continues to show the recommended gauge. However, the custom gauge can now be filled out. Modifying the gauge will result in the sweater instructions and charts changing dramatically.

If an entered value is too large or invalid in any way a dialog tells the user what the maximum value is. For example, if the user makes a swatch that is 400 inches wide, the dialog would say “The swatch width cannot be more than 20 inches”.

Needle sizes in the drop down will generally follow a conventional yarn standards table, possibly with the addition of additional sizes such as, size 2 mm=US size zero. The display in the pulldown may be US size (mm), i.e. the metric goes in the brackets.

In this particular embodiment, the print button on the knit screen will print the actual contents of the active area (e.g. All or Instructions) NOT a screen shot. This is different from other screens. The print at the top of the screen continues to function as a simple print screenshot tool.

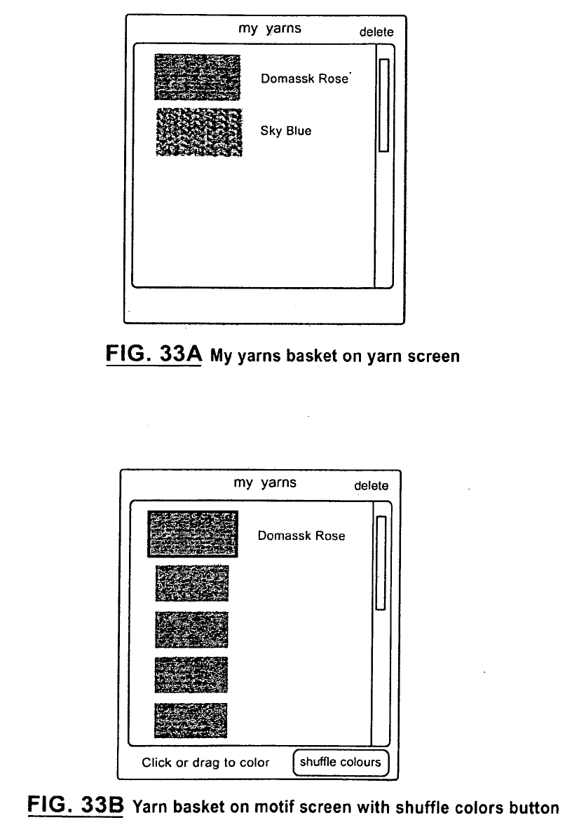

### My Projects Screen (FIG. 32)

The “my projects” screen shows old project that the user had created. There is no first level in the two level toolbar, but buttons for new project, details and deleting a project are available.

To open a project a user can double click a sweater, or select a sweater and hit the “open” button. When the sweater is opened the user is taken to the instructions screen. If this is not possible because the user hasn't got that far, then the user is taken to the last available screen. When no yarns have been applied to the sweater, and the project is saved, a blank template sweater will be shown.

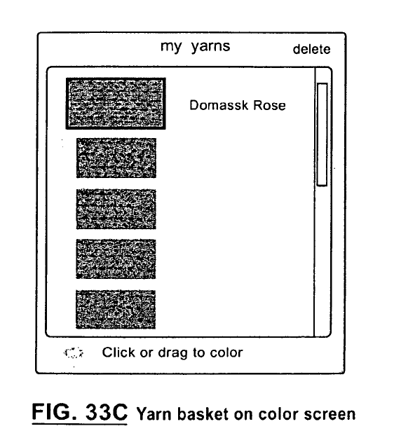

Yarn Basket—Overview (FIGS. 33a, 33b, and 33c)

Yarns are added to the basket by single clicking a swatch on the ‘Yarn’ screen. A subsequent click on a “selected” yarn removes it from the basket.

Yarns can be removed from the basket in two ways:
By single clicking a yarn to select and hitting the ‘Delete’ or ‘Backspace’ key on the keyboard or hitting the delete button
By right clicking the swatch and selecting ‘Remove Yarn’ from the context sensitive menu

On the ‘Color’ screen, double clicking a yarn in the basket colours the background of the active component with that yarn. On all screens, hovering over a yarn in the basket gives more information (tooltip style). The information will include “Family name, Yarn name, Materials” for example “Canadiana, Blue Oyster, 65% Acrylic”. On all screens, Right clicking on a yarn in the basket gives a context sensitive menu with 2 options (Delete Yarn; Delete All Yarns). Double click on a yarn in the “Color” screen changes the sweater background on all components with the selected yarn color. (more about this later).

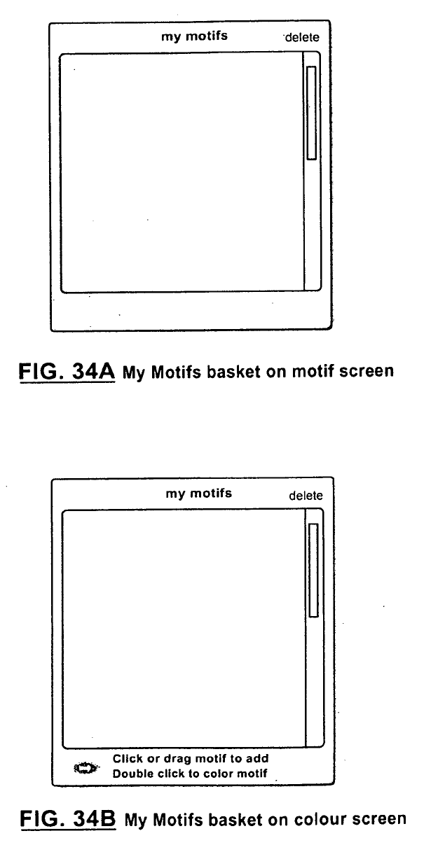

### Motif Basket—Overview (FIGS. 34A and 34B)

Initially the motif basket is empty. Motifs are added to the basket by single clicking a motif on the “Motif” screen. A subsequent click on a “selected” motif removes it from the basket. When a motif is selected in the basket, and the delete button is pressed the motif is deleted. A right click on the motif and “Remove motif” also works. If no motif is selected, the delete button does nothing and is disabled.

Motifs can be removed from the basket in two ways:
By single clicking a motif to select and hitting the ‘Delete’ or ‘Backspace’ key on the keyboard or clicking the trash icon
By right clicking the motif and selecting ‘Remove Motif’ from the context sensitive menu

Double click of a motif in the motif basket launches the motif painter dialog with the motif (this is described further below).

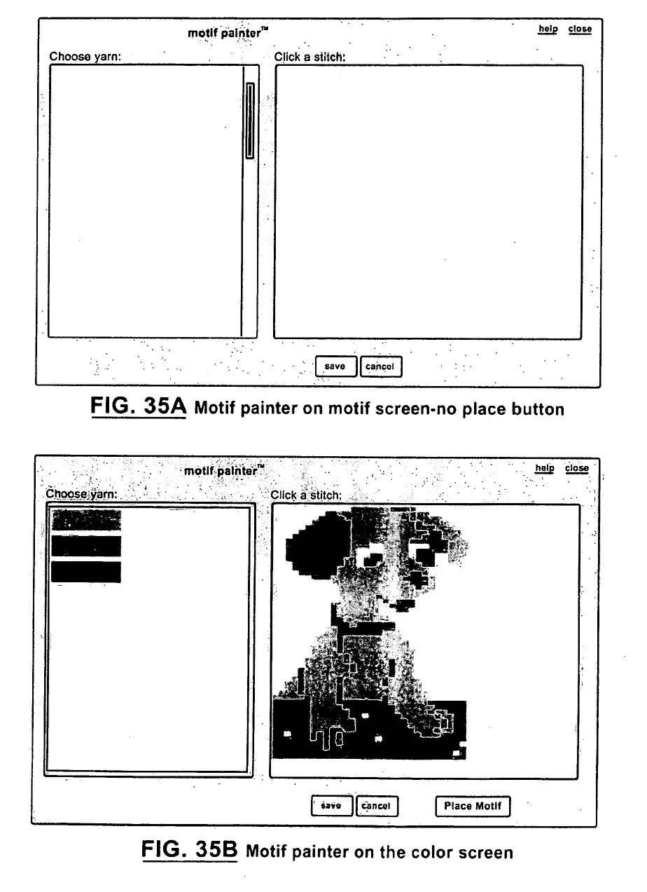

### Motif Painter (FIGS. 35A and 35B)

The motif painter allows a user to custom paint a motif in an easy to use manner. Opened when a user double clicks on a motif in the basket in the motif screen or the color screen.

Motif painter can be opened from the “motif” and “color” screen by clicking on a motif in the basket. The Motif painter is opened by double-clicking a motif in the ‘My motifs’ basket. When launched the first yarn is selected and the user can paint a square on the motif. Clicking ‘Save’ saves the current colour selection back to the motif in the basket. The dialog remains open. Clicking ‘Cancel’ closes the dialog and abandons any colour changes since the last save.

On the “color” screen, clicking ‘Place Motif’ saves, closes the dialog and places a copy of the motif on the active component in the designer screen, surrounded by a movable, resizable marquee. The ‘Place Motif’ button is hidden when on the “motif” screen.

Clicking on a yarn swatch ‘loads’ the brush with that colour and highlights the swatch to show current selection. Moving the mouse over the motif highlights areas in the same colour group with a visual cue (interactive highlight). Clicking within an area colours all areas within that group with the currently selected yarn color.

When a motif has been placed on the sweater already and the motif painter is used to modify it, all versions of the motif on the screen are updated.

### Gauge Change Examples

Gauge changes can occur in various situations, including with: the overall user gauge tool described above; the placement of patterns on the object, the addition of different stitch patterns/types in an object, or based on different yarns that may be used in motifs, and the like.

When changing the overall user gauge, the effect will be to:

1-Change the number of stitches and rows

2-Change the stitch's width and height

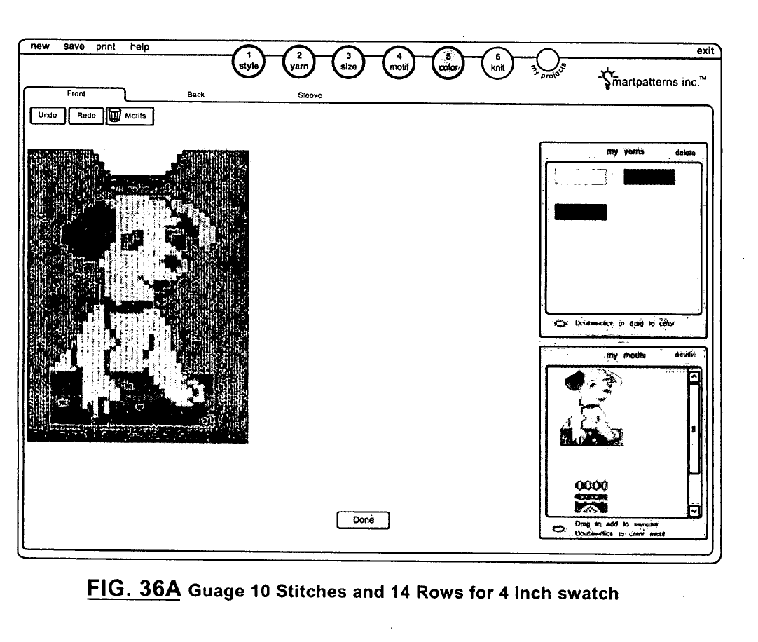

Such changes will typically affect the material consumption and the look of patterns/motifs. The new gauge input by the user is applied to the grid-based template representing the selected style, selected size and selected yarn(s) using a transform to calculate a new grid-based template for the selected gauge as illustrated in FIGS. 36A and 36B.

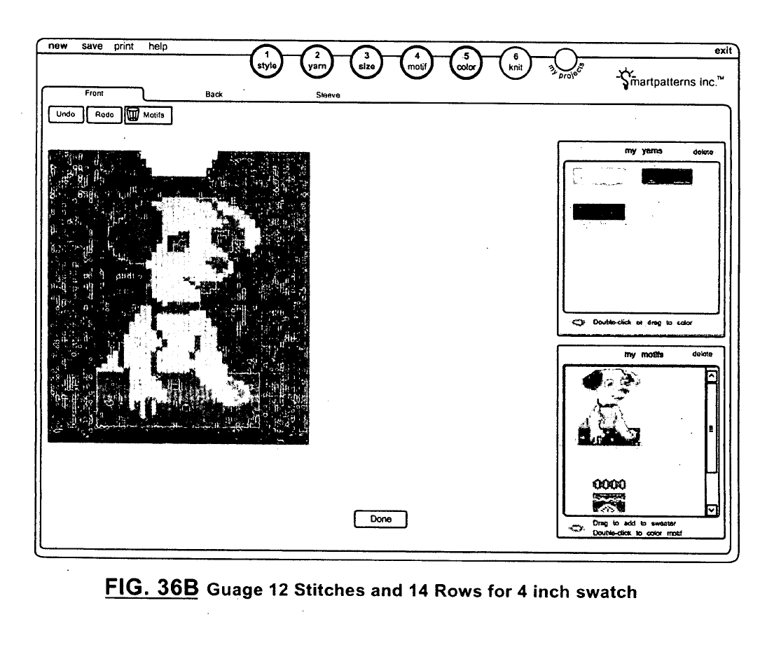

Changing patterns, such as tiling motifs, can also result in changing the gauge and thus changes the number and rows for the garments. This is particularly true where different types of yarn are used for the pattern/motif. Similar to the overall gauge change, the new arrangement of the pattern/motif results in a new grid-based template as illustrated in FIGS. 37A and 37B.

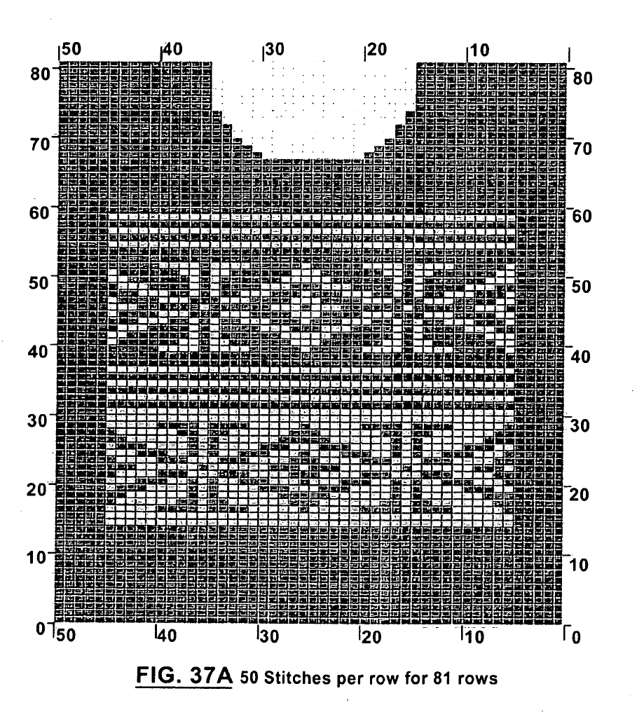

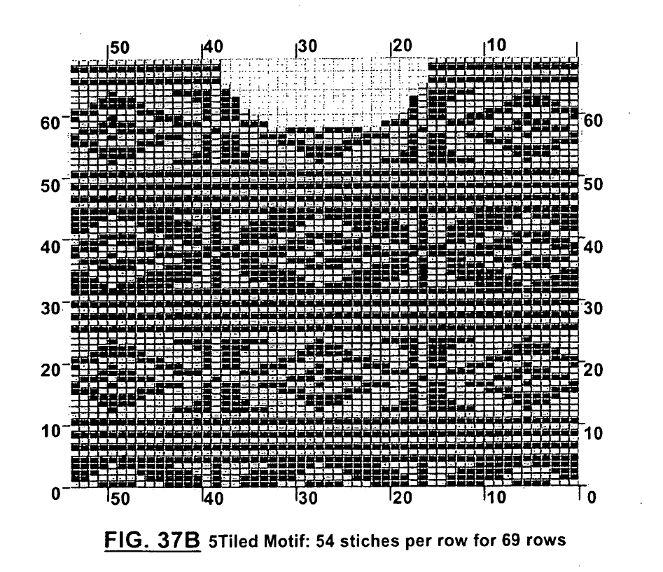

When using more than one gauge in one project due to using different stitch patterns or types (for example, motifs (perhaps with a different stitch style as shown in FIG. 38), cables and multi technique projects) and the like, a sub-template can be created for the pattern while the base template is based on the base gauge (i.e. the gauge for the basic yarn). The sub-template (or secondary layout) uses measurements calculated based on the stitch, yarn and technique used. The sub-template can then be overlaid on the base template and integrated as illustrated in FIG. 39.

In this situation, each sub-template has:

Position related to the base template

Width and height

Technique

Gauge

Stitch dimensions

and these elements are applied to the base template and can be transformed in a similar way to the base template.

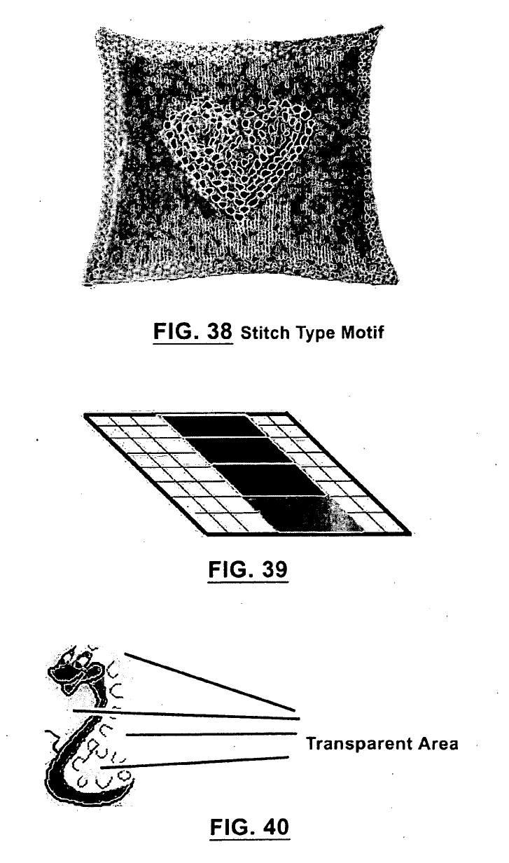

In some cases, it may be convenient to deal with patterns/motifs as rectangular sub-templates in which some areas on the sub-template can be considered transparent, as illustrated in FIG. 40. In this case, the transparent areas are replaced with the colour, stitch and technique from the base template underneath during rendering, calculations and the like.

### EXAMPLE EQUATIONS

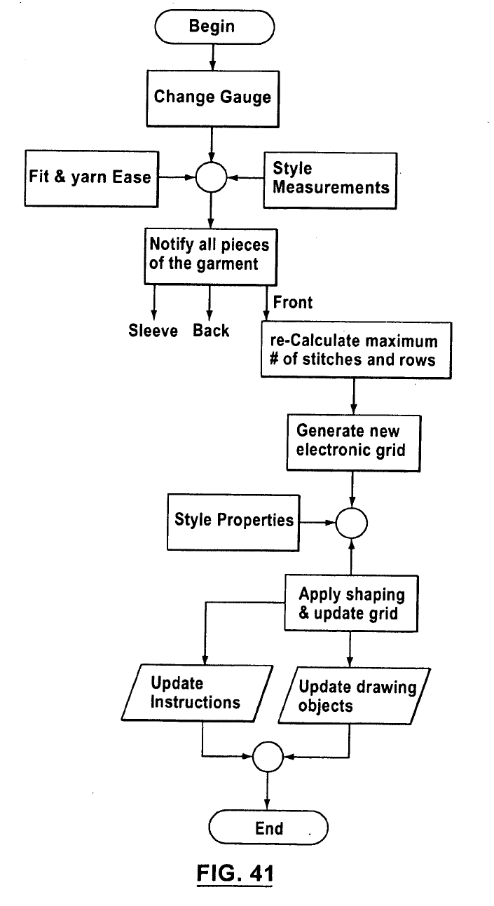

This section provides an example of a change in gauge of a sweater due to a change in user gauge or due to a tiling of a motif. As noted above, the actual measurements of the garment don't change. The process is outlined in the flowchart shown in FIG. 41.

As noted above, the gauge is usually provided based on a material swatch of 4 inches×4 inches. As such, the changed gauge (x, y) is provided where:

X: number of stitches per 4 inches

Y: number of rows per 4 inches.

At this point, the fit and yarn ease as well as the style measurements will already be know from earlier phases of the design process. These variables are available for the calculation.

A similar calculation process is performed for each piece/component of the design, for example, sleeve, front, back or the like. In this example, the example is shown for the front.

The new gauge (Gauge1) is used to re-calculate stitch width and stitch height based on maximum width and height for the component as follows:
Loop through the points for the component [P₀ . . . Pₖ]
If P_{n.x}−P_{n-1.x}>max_width then max_width=P_{n.x}−P_{n-1.}x
If P_{n.y}−P_{n-1.y}>max_height then max_height=P_{n.y}−P_{n-1.y}
Max_#_stitches=max_width * Gauge.x/4
Max_#_rows=max_height * Gauge.y/4
stitch_width=max_width/Max_#_stitches
stitch_height=max_height/Max_#_rows
When gauge changes to Gauge1(X, Y)
New_max_#_stitches=max_width * Gauge1.x/4
New_max_#_rows=max_height * Gauge1.y/4
New_stitch_width=New_max_width/Max_#_stitches
New_stitch_height=New_max_height/Max_#_rows

This provides a new grid-based template (electronic grid) for the design. The style properties that are particular to the style (such as neck type or the like) are then applied to the grid-based template and updated to the new gauge. This is referred to as “applying shaping”. Here we use the example of a v-neck on a sweater.
Neck_width_#_stitches=Neck_width * Gauge.x/4
Neck_depth_#_rows=Neck_depth * Gauge.x/4
#_stitches_shaped (on each side)=Neck_width_#_stitches/2
We remove #_stitches_shaped on each side of the neck over Neck_depth_#_rows
When gauge change to Gauge1(X, Y)
New_neck_width_#_stitches=Neck_width * Gauge1.x/4
New_neck_depth_#_rows=Neck_depth * Gauge1.x/4
New_#_stitches_shaped (on each side)=New_neck_width_#_stitches/2

The embodiments herein have been disclosed with a certain degree of particularity for the purpose of description but not of limitation. Those skilled in the art will appreciate that numerous modifications and variation can be made to the embodiments without departing from the spirit and scope of the application.

While the above description provides examples of one or more processes or apparatuses, it will be appreciated that other processes or apparatuses may be within the scope of the disclosure. It will also be understood that the processes and apparatuses may be implemented using hardware or software components or an appropriate combination thereof. Software may be provided on a physical computer medium or the like for execution on a processor. It will also be understood that various elements may be provided via networks such as the Internet or the like.

We claim:

1. A method for designing a stitched object, the method comprising:
determining a style;
determining a size;
determining a stitch material;
automatically calculating a grid-based template based on the determined style, size and stitch material; and
outputting the grid-based template to a user as a design for the stitched object.

2. A method according to claim 1, wherein the calculating a grid-based template comprises determining a base template for the determined style, applying the determined size to the template to produce a sized template, and applying a property of the determined stitched material to the sized template to produce the grid-based template.

3. A method according to claim 2, further comprising:
determining a pattern; and
wherein the calculating is also based on the determined pattern.

4. A method according to claim 3, wherein the grid-based template is designated a material-specific template and the calculating a grid-based template comprises applying the pattern to the material-specific template to produce the grid-based template.

5. A method according to claim 2, further comprising:
determining a user gauge; and
wherein the calculating is also based on the user gauge.

6. A method according to claim 5, wherein the grid-based template is designated a material-specific template and the calculating a grid-based template comprises applying the user gauge to the material-specific template to produce the grid-based template.

7. A method according to claim 1, wherein the outputting comprises generating instructions for making the stitched object based on the grid-based template and outputting the instructions to a user.

8. A method for designing a stitched object, the method comprising:
receiving a grid-based template for the object;
receiving a new gauge for the object;
automatically calculating a new grid-based template for the object; and
outputting the new grid-based template to a user as a design for the stitched object.

9. A method according to claim 8, wherein the new gauge is received by user input of a user gauge.

10. A system for designing a stitched object, the system comprising:
a style module for input of a style;
a size module for input of a size;
a stitch material module for input of a stitch material to be used;
a calculation module configured to automatically calculate a grid-based template based on the determined style, size and stitch material; and
an output module configured to output the grid-based template to a user as a design for the stitched object.

11. A system according to claim 10, wherein the calculation module is configured to calculate a grid-based template by determining a base template for the determined style, applying the determined size to the template to produce a sized template, and applying a property of the determined stitched material to the sized template to produce the grid-based template.

12. A system according to claim 11, further comprising:
a pattern module for input of a pattern; and
wherein the calculating module is configured to calculate the grid-based template also based on the determined pattern.

13. A system according to claim 12, wherein the calculating module is configured to designate the grid-based template a material-specific template and apply the pattern to the material-specific template to produce the grid-based template.

14. A system according to claim 11, further comprising:
a user gauge module for determining a user gauge; and
wherein the calculating module is configured to calculate the grid-based template also based on the user gauge.

15. A system according to claim 14, wherein the calculating module is configured to designate the grid-based template a material-specific template and apply the user gauge to the material-specific template to produce the grid-based template.

16. A system according to claim 10, wherein the output module is configured to generate instructions for making the stitched object based on the grid-based template and output the instructions to a user.

17. A system for designing a stitched object, the system comprising:
a receiving module configured to receive a grid-based template for the object;
a gauge module configured to receive a new gauge for the object;
a calculating module configured to automatically calculate a new grid-based template for the object; and
an output module configured to output the new grid-based template to a user as a design for the stitched object.

18. A physical computer readable medium containing instructions for designing a stitched object, which when executed on a computer, cause the computer to perform the method of:
determining a style;
determining a size;
determining a stitch material;
automatically calculating a grid-based template based on the determined style, size and stitch material; and
outputting the grid-based template to a user as a design for the stitched object.

19. A physical computer readable medium containing instructions for designing a stitched object, which when executed on a computer, cause the computer to perform the method of:
receiving a grid-based template for the object;
receiving a new gauge for the object;
automatically calculating a new grid-based template for the object; and
outputting the new grid-based template to a user as a design for the stitched object.

20. A method for designing a stitched object, the method comprising:
determining a style;
determining a size;
determining a stitch material;
determining a pattern;
determining a user gauge;
automatically calculating a grid-based template based on the determined style, size, stitch material, pattern, and user gauge; and
outputting the grid-based template to a user as a design for the stitched object.
